(19) United States
(12) Patent Application Publication
(10) Pub. No.: US 2021/0257878 A1
(43) Pub. Date: Aug. 19, 2021

(54) ELECTRIC MOTOR

(71) Applicant: LG Electronics Inc., Seoul (KR)

(72) Inventors: Jongsu KIM, Seoul (KR); Taehee KWAK, Seoul (KR); Jungwook MOON, Seoul (KR); Changhum JO, Seoul (KR)

(21) Appl. No.: 17/252,576

(22) PCT Filed: Jun. 14, 2019
(86) PCT No.: PCT/KR2019/007170

§ 371 Date: Dec. 15, 2020

(30) Foreign Application Priority Data
Jun. 15, 2018 (KR) 10-2018-0069185
Jul. 12, 2018 (KR) 10-2018-0081224
Jul. 31, 2018 (KR) 10-2018-0089405

(51) Int. Cl. H02K 5/20; B60K 11/02; H02K 9/19

(52) U.S. Cl. CPC H02K 5/203; H02K 9/19; B60K 11/02

(57) ABSTRACT

The present invention relates an electric motor comprising: a motor housing; a stator disposed inside the motor housing; and a rotor rotatably installed inside the stator, wherein the motor housing comprises: an outer housing including a first cooling fluid channel through which oil flows; an inner housing disposed inside the outer housing; and a plurality of injection holes formed in the inner housing to communicate with the first cooling fluid channel, so as to inject the oil to the inside of the inner housing, and the inner housing comprises: a plurality of fluid channel forming parts extending inside the inner housing along the circumferential direction thereof; a fluid channel guide extending along the lengthwise direction of the inner housing; and a common header disposed between the plurality of fluid channel forming parts and the fluid channel guide to distribute the cooling water to the second cooling fluid channel or to collect the cooling water from the second cooling fluid channel.

### BACKGROUND

### 1. Technical Field

The present disclosure relates to an electric motor having an oil cooling and water cooling complex cooling passage structure.

### 2. Description of the Related Art

In recent years, electric vehicles (including hybrid vehicles) having an electric motor as a driving source for the vehicle have excellent fuel economy and have been launched as future vehicles.

In general, an electric motor includes a rotor and a stator, and the rotor may be rotatably provided inside the stator.

The stator has a stator coil wound around a stator core, and when current flows through the stator coil to rotate the rotor, heat is generated from the stator coil, and technologies for cooling the heat generated from the electric motor have been developed.

In a drive system including a motor of an electric vehicle and an inverter for driving the motor, cooling heat generated by the motor and the inverter perform an important role in the aspects of downsizing and efficiency improvement of the drive system.

In a motor cooling method in the related art, an indirect cooling method in which coolant is circulated inside a housing to indirectly cool the motor, and a direct cooling method in which the motor is directly cooled by injecting oil into the stator or the rotor have been employed.

The direct cooling method has an advantage in that the cooling efficiency is high and cooling performance is good compared to the indirect cooling method, and thus research and development of the direct cooling method has been actively progressed.

Furthermore, prior patent technical documents on an electric motor to which a direct cooling method in the related art is applied are as follows.

Patent Publication No. 10-2015-0051682 (hereinafter, Patent Document 1) discloses a motor cooling structure in which oil immersed in a bottom surface of a motor housing is pumped by an oil churning device to directly cool a stator, a rotor, and a shaft.

However, Patent Document 1 does not have an injection device that directly injects oil into the stator coil, which generates the most heat, so there is a limit to improving the cooling performance of the motor, for example, there is a limit to cooling a drive motor for a vehicle of 50 kW or higher.

In addition, US 2004/0163409 A1 (hereinafter, Patent Document 2; Pub. Date: Aug. 26, 2004) discloses a motor cooling structure that individually uses an oil cooling type or a water cooling type for motor cooling.

In case of the oil cooling type in Patent Document 2, an oil passage is configured to surround the stator coil, and the oil absorbs heat generated from the stator coil, thereby directly cooling the motor.

In case of the oil cooling type, a heat exchanger is provided outside the motor housing, and is configured to exchange oil absorbing heat from the stator coil with coolant to cool the oil.

In addition, in case of the water cooling type, a coolant passage is disposed inside the motor housing, and coolant flowing through the coolant passage cools the motor housing and transfers heat generated from the stator coil to the stator core and motor housing, thereby indirectly cooling the motor.

However, Patent Document 2 has the following problems.

First, in case of the oil cooling type, cooling efficiency and cooling performance are good, but a heat exchanger must be separately provided at an outside of the housing to lower the temperature of oil, thereby causing an increase in cost and a disadvantage in downsizing the electric motor.

Second, in case of the water cooling type, there is an advantage in that a heat exchanger does not need to be separately provided, but there is a disadvantage in that cooling efficiency and cooling performance are deteriorated.

On the other hand, in case of the oil cooling type in Patent Document 2, an oil cooling passage is provided in a slot of the motor to surround an outside and an inside of the stator coil protruding from the stator core in an axial direction. Oil is circulated by an oil pump to absorb heat generated from the stator coil while flowing along the oil cooling passage, thereby directly cooling the motor.

However, Patent Document 2 has the following problems.

First, there is a problem in that the flow resistance increases when a length of the oil passage increases to dissipate more heat from the stator coil.

Second, there is a problem in that an oil pump must be increased to a large capacity when the passage resistance is large.

Third, when a large-capacity oil pump is attached to the motor housing, there is a problem that it becomes an obstacle to downsizing and lightening the motor.

Fourth, the stator core has a cylindrical shape in which a plurality of electrical steel sheets are stacked and coupled, and there is a problem in that it is difficult to fix the oil cooling passage in the slot of the motor.

Fifth, the oil pump is provided outside the motor housing, and the oil cooling passage is disposed to surround the stator coil on one side surface of the stator core at an inner side of the housing, and there is a problem in that it is difficult to form a connection structure for connecting the oil pump and the oil cooling passage.

### SUMMARY

The present disclosure is created to solve the problems of the related art, and a first object thereof is to provide an electric motor having a complex cooling passage structure to which oil cooling type and water cooling type can be applicable at the same time, thereby improving cooling efficiency and cooling performance as well as greatly contributing to cost reduction and downsizing of electric motors because there is no need to provide a heat exchanger separately outside a motor housing.

A second object of the present disclosure is to provide an electric motor having an injection hole through which oil can be directly injected to a stator, thereby increasing cooling efficiency and improving cooling performance.

A third object of the present disclosure is to provide an electric motor having a plurality of oil pumps pumping oil in opposite directions on both sides of a motor housing, thereby reducing the resistance of an oil passage.

A fourth object of the present disclosure is to provide an electric motor in which a length of an oil passage is reduced, thereby reducing the pressure loss of oil.

A fifth object of the present disclosure is to provide an electric motor capable of reducing pressure loss in an oil passage, thereby allowing a low-capacity pump of an oil pump to be applicable thereto, and producing high output even with the low-capacity oil pump.

A sixth object of the present disclosure is to provide an electric motor provided with a low-capacity oil pump, thereby greatly contributing to downsizing and weight reduction.

A seventh object of the present disclosure is to provide an electric motor in which an oil distributor for injecting oil directly onto a stator coil is fixed onto an inner ceiling of a housing in a hanging manner, thereby facilitating the fixation of the oil distributor.

In addition, an eighth object of the present disclosure is to provide an electric motor in which an oil passage is disposed inside a motor housing to connect the oil distributor and the oil pump, and an oil passage connection portion connecting the oil passage and the oil distributor is extended downward from an inner ceiling of the motor housing to the oil distributor, thereby eliminating the need for a separate connection structure to connect the oil pump and the oil distributor.

In order to achieve the foregoing first object, an electric motor according to the present disclosure may include a motor housing; a stator provided with a stator coil, and disposed at an inner side of the motor housing; and a rotor rotatably provided at an inner side of the stator, wherein the motor housing includes an outer housing having a first cooling passage through which oil flows therein; an inner housing disposed inside the outer housing, and provided with a second cooling passage through which coolant flows therein to enable heat exchange with the first cooling passage.

In order to achieve the foregoing second object, the electric motor may further include a plurality of injection holes disposed inside the inner housing to communicate with the first cooling passage so as to inject the oil into the inner housing.

According to such an oil-water cooling complex cooling structure, oil may flow along the first cooling passage disposed inside the outer housing, and may be directly injected to the stator coil located at an inner side of the inner housing through a plurality of injection holes to directly cool the stator coil generating the most heat, or the like, thereby improving cooling efficiency and cooling performance, which are advantages of a direct cooling method.

In addition, coolant may flow along the second cooling passage disposed inside the inner housing, and is disposed at an inner side of the outer housing to exchange heat with the oil to cool oil, thereby eliminating the need to separately provide a heat exchanger outside the motor housing to greatly contribute to cost reduction and downsizing of the electric motor.

According to an example associated with the present disclosure, the first cooling passage and the second cooling passage may extend in directions crossing each other.

According to an example associated with the present disclosure, the first cooling passage may extend in a length direction of the outer housing, and the second cooling passage may extend in a circumferential direction of the inner housing.

According to an example associated with the present disclosure, the outer housing may include a plurality of heat exchange cells extending along a length direction inside the outer housing; a plurality of partition walls provided between the plurality of heat exchange cells to partition the plurality of heat exchange cells; and a plurality of communication passages disposed at a front or rear end portion of each of the plurality of partition walls to communicate the plurality of heat exchange cells so as to define the first cooling passage.

According to an example associated with the present disclosure, the plurality of partition walls may be disposed to protrude from an inner wall of the outer housing in a radial direction and connected to an outer wall of the outer housing, and the plurality of communication passages may be alternately disposed at front and rear ends of the outer housing along a circumferential direction.

According to an example associated with the present disclosure, the inner housing may include a plurality of passage formation portions extending in a circumferential direction inside the inner housing; a passage guide spaced apart from the plurality of passage formation portions along a circumferential direction to extend along a length direction of the inner housing; and a common header provided between the plurality of passage formation portions and the passage guide to distribute coolant to the second cooling passage or collect the coolant from the second cooling passage, wherein the second cooling passage is disposed between the plurality of passage formation portions.

According to an example associated with the present disclosure, the plurality of passage formation portions may be disposed to protrude radially outward from an inner wall of the inner housing, and the inner housing may be press-fitted and coupled to an inside of the outer housing to allow an outer end of each of the plurality of passage formation portions to be brought into contact with an inner wall of the outer housing.

According to another example associated with the present disclosure, the outer housing may include a plurality of passage formation portions extending in a circumferential direction inside the outer housing to define a plurality of the first cooling passages; a passage guide spaced apart from the plurality of passage formation portions along a circumferential direction to extend along a length direction of the outer housing; and a common header provided between the plurality of passage formation portions and the passage guide to distribute coolant to the second cooling passage or collect the coolant from the second cooling passage.

According to another example associated with the present disclosure, the inner housing may include a plurality of heat exchange cells extending along a length direction inside the inner housing; a plurality of partition walls provided between the plurality of heat exchange cells to partition the plurality of heat exchange cells; and a plurality of communication passages disposed at a front or rear end portion of each of the plurality of partition walls to communicate the plurality of heat exchange cells so as to define the second cooling passage.

According to an example associated with the present disclosure, each of the plurality of injection holes may extend in a radial direction at an inner upper portion of the inner housing to inject the oil into the stator coil.

According to an example associated with the present disclosure, the plurality of injection holes may be disposed at front and rear end portions, respectively, along a length direction of the inner housing.

According to an example associated with the present disclosure, the outer housing may have a cell outlet port communicating the first cooling passage with the plurality of injection holes.

According to an example associated with the present disclosure, the electric motor may further include an oil inlet port disposed on a bottom surface of the inner housing; and an oil pump mounted on one side surface of the outer housing to pump oil flowing in through the oil inlet port into the plurality of injection holes.

According to an example associated with the present disclosure, the outer housing may include a first semicircular portion disposed in one section along a circumferential direction; and a second semicircular portion disposed in the other section along the circumferential direction to have a diameter larger than that of the first semicircular portion so as to define the first cooling passage therein.

According to an example associated with the present disclosure, the outer housing may include a coolant inlet port disposed at an upper portion of the first semicircular portion; and a coolant outlet port disposed at a lower position along a circumferential direction from the coolant inlet port.

In order to achieve the third to sixth objects of the present disclosure, an electric motor according to the present disclosure may include a motor housing that accommodates a stator and a rotor thereinside; a plurality of oil passages extending in directions opposite to each other along a circumferential direction inside the motor housing to allow oil to flow; a plurality of oil pumps communicating with each of the plurality of oil passages to move oil from one side of each of the plurality of oil passages to the other side thereof; a plurality of oil inlet ports disposed at a lower portion of the motor housing to allow the oil to flow in to one side of each of the plurality of oil passages; and a plurality of injection nozzles disposed at an upper portion of the motor housing to inject the oil from the other side of each of the plurality of oil passages into an upper inner space of the motor housing.

According to this configuration, a circumferential length of the oil passage may be increased from 180 degrees to 360 degrees in order to enhance the heat dissipation performance of oil, but a plurality of oil pumps may be mounted on both sides of the motor housing to reduce a circumferential length of the oil passage pumped by one oil pump from one circumference from to a semi-circumference so as to decrease the flow resistance of oil, thereby reducing the pressure loss of oil.

According to another example associated with the present disclosure, a plurality of oil passages may include a first oil passage extending in a clockwise direction from a lower center of the motor housing; and a second oil passage extending in a counterclockwise direction from a lower center of the motor housing.

According to another example associated with the present disclosure, a plurality of oil inlet ports may include a first oil inlet port extending in a length direction at a front half portion of the motor housing; and a second oil inlet port extending along a length direction at a rear half portion of the motor housing.

According to another example associated with the present disclosure, the plurality of injection nozzles may include a first injection nozzle disposed at a front half portion of the motor housing to pass therethrough in a thickness direction; and a second injection nozzle disposed at a rear half portion of the motor housing to pass therethrough in a thickness direction.

According to another example associated with the present disclosure, each of the plurality of oil passages may include a plurality of heat exchange cells extending along a length direction of the motor housing, and spaced apart along a circumferential direction of the motor housing; a plurality of partition walls partitioning the plurality of heat exchange cells in a circumferential direction; and a plurality of communication holes disposed at a front or rear end portion of each of the plurality of partition walls to communicate two adjacent heat exchange cells along the circumferential direction.

According to another example associated with the present disclosure, the plurality of oil inlet ports may be spaced apart in a length direction of the motor housing, and a partition wall disposed at the lowermost end of the plurality of partition walls may partition the plurality of oil inlet ports spaced apart in the length direction.

According to another example associated with the present disclosure, the plurality of injection nozzles may be spaced apart in a length direction of the motor housing, and the partition wall disposed at the uppermost end of the plurality of partition walls may partition the plurality of injection nozzles spaced apart in the length direction.

According to another example associated with the present disclosure, an electric motor according to the present disclosure may further include a coolant passage disposed separately from the plurality of oil passages inside the motor housing, and disposed at an inner side of the plurality of oil passages to allow coolant to flow.

According to another example associated with the present disclosure, the motor housing may include an outer housing disposed with the plurality of oil passages therein; and an inner housing disposed with the coolant passage therein.

According to another example associated with the present disclosure, the coolant passage may include a plurality of coolant channels extending in a circumferential direction of the motor housing, and spaced apart from each other in a length direction of the motor housing.

According to another example associated with the present disclosure, an electric motor according to the present disclosure may further include a controller that controls the plurality of oil pumps, wherein the controller stops the plurality of oil pumps during the low-speed and low-torque of the electric motor, and cools the electric motor using only the coolant, and operates at least one of the plurality of oil pumps during the high-speed and high-torque of the electric motor.

In order to achieve the seventh and eighth objects of the present disclosure, an electric motor according to the present disclosure may include a motor housing that accommodates a stator and a rotor thereinside; a first cooling passage disposed inside the motor housing to allow oil to flow; a second cooling passage disposed separately from the first cooling passage inside the motor housing to allow coolant to flow; an oil distributor extending along a circumferential direction in an inner space of the motor housing; a plurality of injection holes spaced apart along a circumferential direction on the oil distributor, and disposed to pass through the oil distributor in a downward direction to inject oil distributed by the oil distributor to the stator coil of the stator; and an oil passage connection portion connecting the first cooling passage and the oil distributor.

According to still another example associated with the present disclosure, the electric motor may further include bearings respectively provided on a cover disposed to cover both opening portions disposed along an axial direction of the motor housing to rotatably support both end portions of a rotation shaft extending along the axial direction at the center portion of the motor housing, wherein the oil distributor further includes a bearing injection nozzle branched from the oil distributor to extend obliquely toward the bearing so as to inject the oil into the bearing.

According to still another example associated with the present disclosure, the motor housing may include an outer housing disposed with the first cooling passage therein; and an inner housing disposed with the second cooling passage therein.

According to still another example associated with the present disclosure, the oil distributor may be disposed at an inner side of the inner housing, and the oil passage connection portion may extend to a central portion on a circumference of the oil distributor from the uppermost end of the outer housing through the inner housing to connect the first cooling passage and the oil distributor.

According to still another example associated with the present disclosure, the oil distributor may include a curved portion provided with the plurality of injection holes and defined in an arc shape; and a side surface portion protruding radially outward from both side surfaces along a width direction of the curved portion, thereby providing an open passage structure that is open upward.

According to still another example associated with the present disclosure, the oil distributor may be configured such that the opening portion that is open upward is covered by an inner circumferential surface of the motor housing.

According to still another example associated with the present disclosure, the first cooling passage and the second cooling passage may extend in directions crossing each other.

According to still another example associated with the present disclosure, the oil distributors may be provided at front and rear end portions of the motor housing, respectively, along a length direction thereof, and the plurality of injection holes may inject oil toward an end coil of the stator coil protruding from both end portions of the stator core along a length direction.

According to still another example associated with the present disclosure, the first cooling passage may include a plurality of heat exchange cells extending along a length direction of the motor housing to be spaced apart from each other in a circumferential direction of the motor housing; a plurality of partition walls disposed between the two adjacent heat exchange cells in the circumferential direction to partition the plurality of heat exchange cells; and a communication passage disposed at a front or rear end portion in a length direction of the plurality of partition walls so as to communicate the plurality of heat exchange cells in a circumferential direction.

According to still another example associated with the present disclosure, plurality of the second cooling passages may extend along a circumferential direction of the inner housing, and the plurality of the extending second cooling passages may be spaced apart in a length direction of the inner housing, and a passage formation portion may be disposed between two second cooling passages adjacent in the length direction, and the passage formation portion may extend along the circumferential direction to define the plurality of second cooling passages.

According to still another example associated with the present disclosure, the plurality of second cooling passages may be configured to be open in a radially outward direction of the inner housing, and covered by an inner circumferential surface of the outer housing.

The effects of an electric motor according to the present disclosure will be described as follows.

First, a plurality of injection holes for injecting oil directly to a stator coil from an upper portion of a housing may be provided to directly cool a motor, thereby improving cooling efficiency and cooling performance.

Second, a first cooling passage disposed at an outer side of the housing to flow oil and a second cooling passage disposed at an inner side of the housing to flow coolant and exchange heat with the first cooling passage may be provided to cool the oil by the coolant while flowing along the first cooling passage until being transferred to an injection port at an upper portion of the housing, thereby reducing the cost of the motor and greatly contributing to downsizing of the motor because a heat exchange system for exchanging heat with oil is not additionally required outside the motor housing.

Third, a complex cooling passage structure in which oil cooling and water cooling are performed at the same time may be provided to further improve heat dissipation performance and achieve a higher output, thereby being used to cool a motor for driving a vehicle of 50 kW or higher. In addition, it may be possible to reduce a size of the electric motor while maintaining the same output of the electric motor.

Fourth, a complex cooling passage may be provided in the motor housing to increase a contact area through which the oil passage and the coolant passage can exchange heat with each other, thereby increasing the heat dissipation performance of the motor.

Fifth, the oil pump and the motor housing may be integrally coupled to each other to downsize the motor, thereby increasing a degree of design freedom when the motor is mounted on a vehicle.

Sixth, inside and outside of the motor housing may be composed of two pieces, thereby facilitating the molding of a double cooling passage.

Seventh, an internal passage of the motor may be provided with a multi-pass passage structure to efficiently maintain flow in a circumferential direction, thereby minimizing flow resistance.

Ninth, a motor core portion and cooling oil may be cooled while flowing through the second cooling passage, which is one of inner passages in a motor housing wall body, and then heat may be dissipated from a radiator, and then recirculated to the motor housing.

Tenth, the end coil and the rotor may be cooled while flowing through the first cooling passage, which is the other one of inner passages in a motor housing wall body, and then heat may be discharged to coolant while flowing through an inner wall of the motor housing, and then recirculated to an inside of the motor housing.

Eleventh, according to a dual passage of the present disclosure, heat dissipation by coolant may be performed in a low heating (low power) condition, and heat dissipation by coolant and cooling oil may be performed in a high heating (high output) condition.

Twelfth, compared to a water cooling method in the related art, oil may be directly injected to enhance heat dissipation efficiency, thereby driving the electric motor at a higher output with the same size housing.

Thirteenth, according to the present disclosure, compared to an oil cooling method in the related art, an oil cooler may be replaced with the second cooling passage disposed inside the housing wall body, thereby achieving cost reduction and compact structure.

Fourteenth, the present disclosure may allow a hybrid operation according to a heating state, thereby having higher efficiency than the oil cooling type in the related art in which the oil pump is operated at all times.

Fifteenth, only coolant may be circulated in a low heating condition in which the outside is in a low temperature state, thereby solving reliability problem due to an increase in oil viscosity at a low-temperature state.

Sixteenth, the temperature of the housing may be maintained lower than that of the oil cooling type in the related art by coolant, thereby improving the lifespan of a bearing.

Seventeenth, even when an oil distributor extending in an arc shape is provided in an inner space of the motor housing, and a plurality of injection holes are spaced apart along a circumferential direction of the oil distributor to eliminate a dead zone (an area where oil is not injected from the stator coil) in an injection area of oil, and oil is drawn to either one side inside the motor housing while the vehicle is driving uphill or downhill, oil may be evenly injected to the stator coil, thereby improving the cooling performance of the electric motor.

Eighteenth, a bearing injection nozzle may be further provided in the oil distributor to inject oil to the bearing through the bearing injection nozzle, thereby improving the cooling performance of the bearing as well as extending the lifespan of the bearing.

Nineteenth, the oil distributor may have an open flow path structure that is open upward to increase a flow cross-sectional area of oil, thereby reducing the pressure loss of oil.

Twentieth, a double passage that allows oil and coolant to flow through separate passages, respectively, may be provided inside the motor housing, and the oil discharges heat absorbed from the stator coil, the bearing, and the like, into the coolant and then recirculates to an inside of the motor housing, thereby improving the heat dissipation performance of the oil.

Twenty-first, according to a dual cooling passage structure of the motor housing, an oil-water cooling complex cooling method may be applied to cool and dissipate heat from the electric motor by coolant in a low heating (low output) condition, and perform heat dissipation by coolant and cooling oil in a high heating (high output) condition, thereby improving output density compared to the water cooling type in the related art to drive the electric motor at a higher output with the same size housing.

Twenty-second, an oil cooler used in the oil cooling type in the related art may be replaced with a double cooling passage disposed inside a wall body of the motor housing, thereby reducing cost and implementing a compact structure of the electric motor.

Twenty-third, a hybrid operation may be carried out according to a heating state of the electric motor, thereby obtaining an advantage of having high efficiency compared to the oil cooling type in the related art in which the oil pump is operated.

Twenty-fourth, only coolant may be circulated in a low heating condition in which the external environment is at a low temperature to increase the viscosity of oil at a low temperature, thereby reducing the reliability of oil cooling.

### BRIEF DESCRIPTION OF THE DRAWINGS

FIG. 1 is a perspective view showing a drive system according to the present disclosure.

FIG. 2 is a perspective view showing a motor housing in FIG. 1.

FIG. 3 is an exploded view showing a state in which an outer housing and an inner housing are disassembled in FIG. 2.

FIG. 4 is a cross-sectional view taken along line IV-IV in FIG. 2.

FIG. 5 is a cross-sectional view taken along line V-V in FIG. 2.

FIG. 6 is a conceptual view showing a movement path of oil flowing along a first cooling passage inside the outer housing in FIG. 3.

FIG. 7 is a conceptual view showing a movement path of coolant flowing along a second cooling passage inside the inner housing in FIG. 3.

FIG. 8 is a cross-sectional view of a motor housing showing a structure of a dual cooling passage according to a second embodiment of the present disclosure.

FIG. 9 is a cross-sectional view of a motor housing showing a structure of a dual cooling passage according to a third embodiment of the present disclosure.

FIG. 10 is a perspective view showing a drive system for an electric vehicle according to the present disclosure.

FIG. 11 is a front view showing a state in which a bidirectional oil pump according to a fourth embodiment of the present disclosure is mounted on a motor housing.

FIG. 12 is a perspective view showing a state in which a plurality of oil inlet ports are arranged at a lower portion of an inner housing in FIG. 11.

FIG. 13 is a bottom view showing a state in which a plurality of injection nozzles are arranged at an upper portion of an inner housing in FIG. 11.

FIG. 14 is a perspective view showing an outer housing after removing the inner housing in FIG. 12.

FIG. 15 is a partially cut-away bottom perspective view for explaining a plurality of oil inlet ports disposed at a lower portion of the outer housing in FIG. 14.

FIG. 16 is a partially cut-away perspective view for explaining a plurality of injection nozzles disposed at an upper portion of the outer housing in FIG. 14.

FIG. 17 is a cross-sectional view taken along line XVII-XVII in FIG. 10.

FIG. 18 is a front view showing a dual passage structure of a motor housing according to a fifth embodiment of the present disclosure.

FIG. 19 is a perspective view showing a drive system for driving a wheel of an electric vehicle according to a sixth embodiment of the present disclosure.

FIG. 20 is a perspective view showing a bottom surface of an oil distributor provided in a hanging manner on a ceiling of the housing at a rear side of the electric motor in FIG. 19.

FIG. 21 is a perspective view showing a state of the oil distributor after removing an inner housing in FIG. 20.

FIG. 22 is a perspective view showing the structure of the oil distributor in FIG. 21.

FIG. 23 is a cross-sectional view taken along line XXIV-XXIV in FIG. 19.

### DETAILED DESCRIPTION OF THE EMBODIMENTS

Hereinafter, the embodiments disclosed herein will be described in detail with reference to the accompanying drawings, and the same or similar elements are designated with the same numeral references regardless of the numerals in the drawings and redundant description thereof will be omitted. A suffix “module” and “unit” used for constituent elements disclosed in the following description is merely intended for easy description of the specification, and the suffix itself does not give any special meaning or function. In describing an embodiment disclosed herein, moreover, the detailed description will be omitted when specific description for publicly known technologies to which the invention pertains is judged to obscure the gist of the present disclosure. Also, it should be understood that the accompanying drawings are merely illustrated to easily explain the concept of the invention, and therefore, they should not be construed to limit the technological concept disclosed herein by the accompanying drawings, and the concept of the present disclosure should be construed as being extended to all modifications, equivalents, and substitutes included in the concept and technological scope of the invention.

It will be understood that, although the terms first, second, etc. may be used herein to describe various elements, these elements should not be limited by these terms. The terms are used merely for the purpose to distinguish an element from another element.

It will be understood that when an element is referred to as being “connected with” another element, the element can be directly connected with the other element or intervening elements may also be present. On the contrary, in case where an element is “directly connected” or “directly linked” to another element, it should be understood that any other element is not existed therebetween.

A singular representation may include a plural representation as far as it represents a definitely different meaning from the context.

Terms “include” or “has” used herein should be understood that they are intended to indicate the existence of a feature, a number, a step, a constituent element, a component or a combination thereof disclosed in the specification, and it may also be understood that the existence or additional possibility of one or more other features, numbers, steps, constituent elements, components or combinations thereof are not excluded in advance.

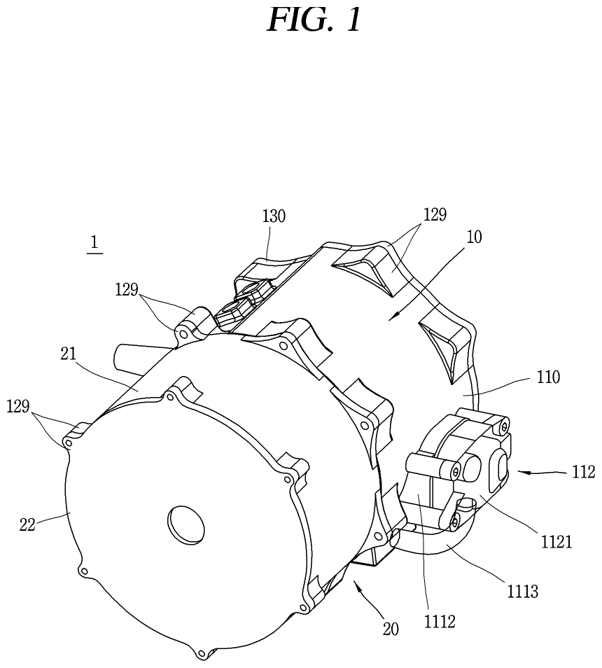

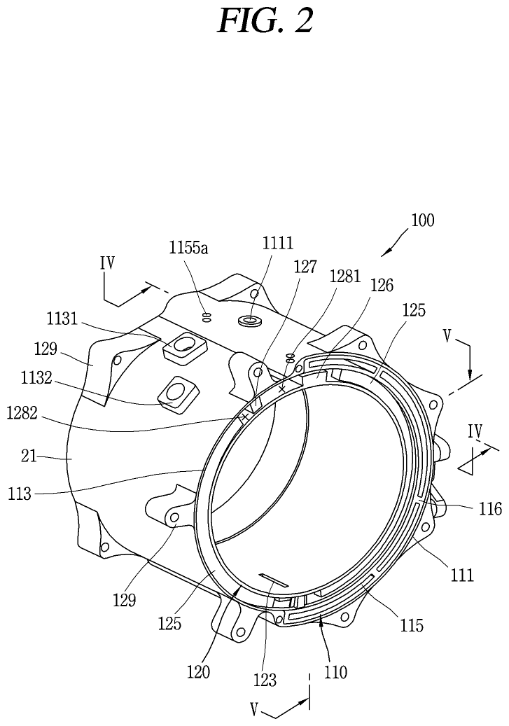

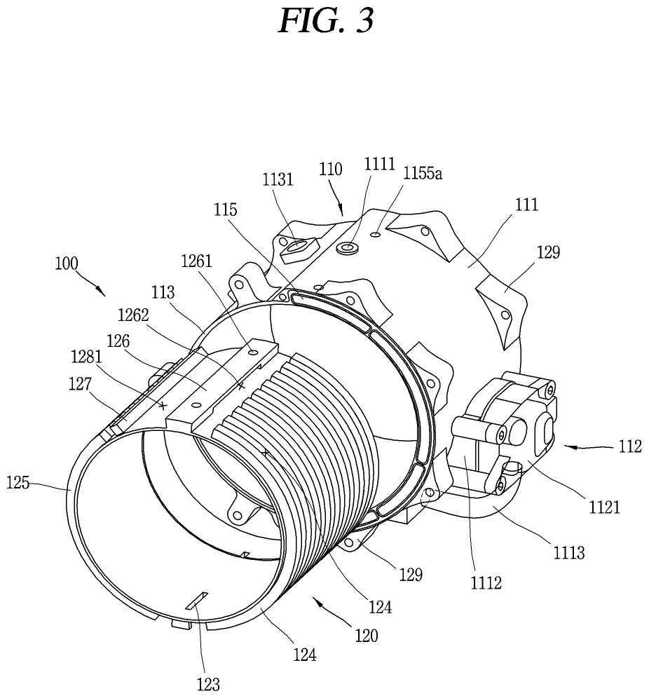

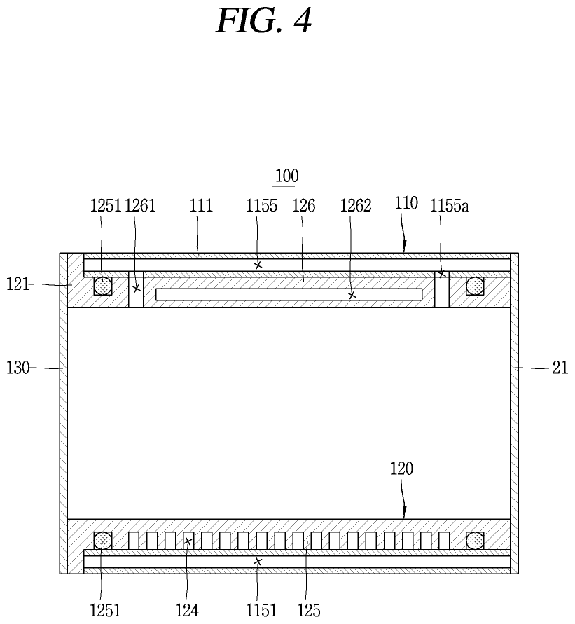

FIG. 1 is a perspective view showing a drive system 1 according to the present disclosure, and FIG. 2 is a perspective view showing a motor housing 100 in FIG. 1, and FIG. 3 is an exploded view showing a state in which an outer housing 110 and an inner housing 120 are disassembled in FIG. 2, and FIG. 4 is a cross-sectional view taken along line IV-IV in FIG. 2.

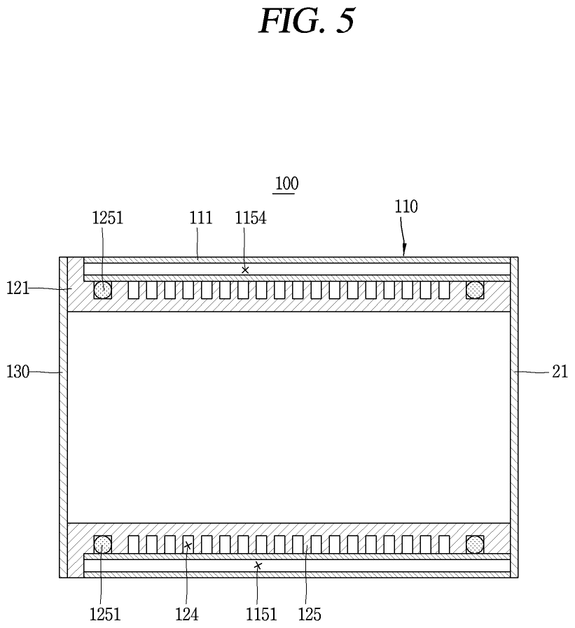

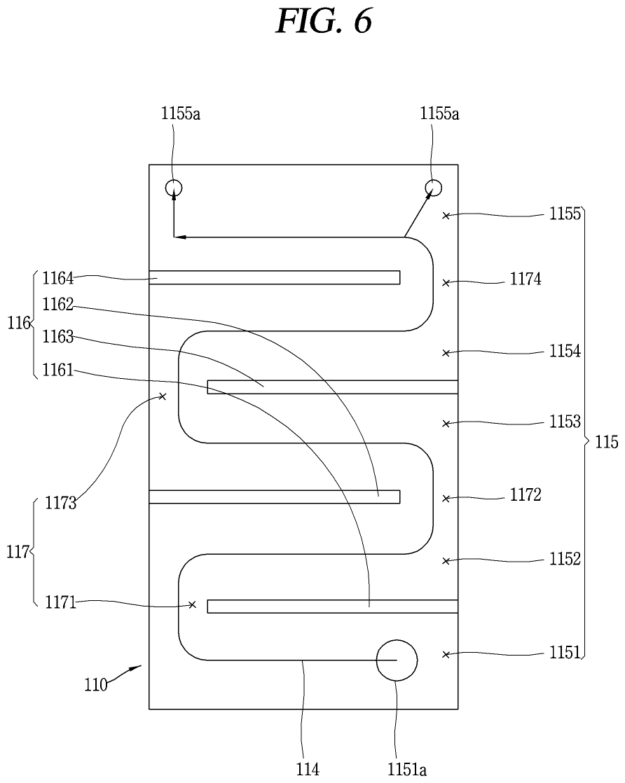

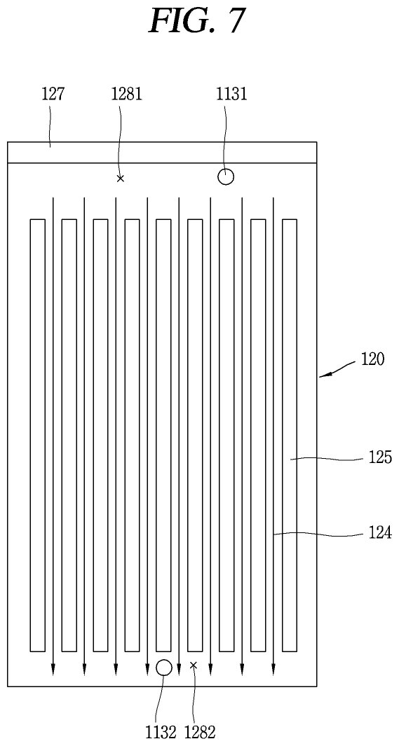

In addition, FIG. 5 is a cross-sectional view taken along line V-V in FIG. 2, and FIG. 6 is a conceptual view showing a movement path of oil flowing along a first cooling passage 114 inside the outer housing 110 in FIG. 3, and FIG. 7 is a conceptual view showing a movement path of coolant flowing along a second cooling passage 124 inside the inner housing 120 in FIG. 3.

The electric motor 10 according to the present disclosure may be applicable to an electric vehicle or a hybrid vehicle. The electric motor 10 may provide a driving force for driving a driving wheel of a vehicle.

The drive system 1 according to the present disclosure is configured to include an electric motor 10 and an inverter 20 for driving the electric motor 10.

The electric motor 10 includes a motor housing 100. A stator and a rotor may be provided inside the motor housing 100. The stator includes a stator core and a stator coil wound around the stator core.

The rotor may be provided inside the stator core, and provided rotatably with respect to the stator. Since rotation shaft is provided inside the rotor, the rotor may be rotatably provided together with the rotation shaft.

The motor housing 100 may be configured in a cylindrical shape to accommodate the stator and the rotor. The motor housing 100 may be open in both directions along an axial direction. The motor housing 100 may include a plurality of fastening portions 129 at front and rear end portions, respectively.

A rear cover 130 is fastened to a rear end portion of the motor housing 100 to cover a rear side of the motor housing 100. The rear cover 130 is configured to cover the rear side of the motor housing 100 in a plate shape, and a plurality of fastening portions 129 may be arranged to be fastened to the motor housing 100.

The inverter 20 is configured to include a cylindrical inverter housing 21 for accommodating electronic components for driving the electric motor 10 therein. The inverter housing 21 may be fastened to a front end portion of the motor housing 100.

The inverter housing 21 is configured to extend in an axial direction from a front end portion of the motor housing 100, and provided with a plurality of fastening portions 129 protruding radially outward from front and rear end portions of the inverter housing 21, respectively. The plurality of fastening portions 129 may be spaced apart in a circumferential direction.

A front cover 22 is fastened to a front end portion of the inverter housing 21 to cover a front side of the inverter housing 21. The front cover 22 may be configured in a circular plate shape. A plurality of fastening portions 129 protruding from an outer circumferential surface of the front cover 22 in a radial direction may be provided.

Each of the front cover 22, the inverter housing 21, the motor housing 100, and the rear cover 130 may be fastened with bolts through fastening holes disposed in the plurality of fastening portions 129.

The motor housing 100 may have double cooling passages. Each of the dual cooling passages may be configured to flow different fluids. One of the dual cooling passages may be configured to allow oil to flow. The other one of the dual cooling passages may be configured to flow coolant.

The motor housing 100 may include an outer housing 110 and an inner housing 120.

The outer housing 110 may be defined in a cylindrical shape having a hollow portion therein.

The outer housing 110 may include a first cooling passage 114 through which oil flows.

To this end, when looking at the motor housing 100 in an axial direction from a front side of the motor housing 100 in which an inverter housing is located, a left semicircular portion 113 and a right semicircular portion 111 have the same inner diameter and different outer diameters. Each of the left semicircular portion 113 and the right semicircular portion 111 may have the same diameter along a length direction.

An upper end portion of each of the left semicircular portion 113 and the right semicircular portion 111 may be disposed to be stepped in a radial direction. A lower end portion of each of the left semicircular portion 113 and the right semicircular portion 111 may be disposed to be stepped in a radial direction.

The right semicircular portion 111 of the outer housing 110 may be disposed to extend more outwardly along a radial direction than the left semicircular portion 113.

The left semicircular portion 113 and the right semicircular portion 111 may have different circumferences. The right semicircular portion 111 extending in a radial direction may have a larger or smaller circumference than the left semicircular portion 113.

The first cooling passage 114 may be provided inside the right semicircular portion 111 extending radially outward.

An oil injection port for injecting oil into the first cooling passage 114 may be disposed at an upper end portion of the right semicircular portion 111. An oil plug 1111 may be detachably mounted to block the oil injection port.

The first cooling passage 114 may define a passage for circulating oil.

The first cooling passage 114 may include a plurality of heat exchange cells 115. The plurality of heat exchange cells 115 may be spaced apart from each other along a circumferential direction of the outer housing 110. Each of the plurality of heat exchange cells 115 may extend along a length direction of the outer housing 110.

The plurality of heat exchange cells 115 may be partitioned by a plurality of partition walls 116 extending in a radial direction. Each of the plurality of partition walls 116 may extend along a length direction of the outer housing 110.

The right semicircular portion 111 is further provided with a communication passage 117 connecting the heat exchange cells 115 adjacent to each other in a circumferential direction to communicate with each other, and the plurality of heat exchange cells 115 may define a single first cooling passage 114.

Each of the plurality of partition walls 116 may be disposed to have a shorter length in a axial direction than the plurality of heat exchange cells 115 to connect two heat exchange cells 115 adjacent to each other in a circumferential direction to communicate with each other.

Each of the plurality of communication passages 117 may be disposed between a front end or a rear end of the plurality of heat exchange cells 115 and one end portion of the partition wall 116, respectively.

Each of the plurality of communication passages 117 may be disposed alternately at the front end portion and the rear end portion of the plurality of heat exchange cells 115 along a circumferential direction.

The rear cover 130 may be coupled to cover rear ends of the plurality of heat exchange cells 115. The rear cover 130 may be alternately and selectively brought into contact with a rear end portion of each of the plurality of partition walls 116 along a circumferential direction.

A rear end portion of the inverter housing 21 may be coupled to cover front ends of the plurality of heat exchange cells 115. The rear end portion of the inverter housing 21 may be alternately and selectively brought into contact with a front end portion of each of the plurality of partition walls 116 along a circumferential direction.

The plurality of heat exchange cells 115 may guide the flow direction of oil together with the partition wall 116 to flow opposite to each other along a length direction of the outer housing 110.

The plurality of communication passages 117 may guide the flow direction of oil to flow along a circumferential direction.

The plurality of heat exchange cells 115 may include first to fifth heat exchange cells 1155 disposed along a circumferential direction from a lower end of the right semicircular portion 111 toward an upper end thereof.

A first heat exchange cell 1151 may include a cell inlet port 1151a communicating with an oil pump 112. The cell inlet port may be connected to communicate with a pump discharge port of the oil pump 112.

An oil inlet port 123 is disposed at a bottom surface of the inner housing 120.

The oil pump 112 may be detachably mounted on a lower right side portion of the motor housing 100. The oil pump 112 may be configured with an electric pump driven by electric energy.

A pump mounting portion 1112 may be disposed to protrude from a lower side portion of the right semicircular portion 111 of the outer housing 110. A pump discharge port may be disposed inside the pump mounting portion 1112. A pump inlet port may be disposed on a bottom surface of the pump mounting portion 1112.

The pump inlet port is connected to communicate with the oil inlet port 123 by a connection hose 1113.

The oil pump 112 may include a pump housing 1121, a pumping blade, and a pumping motor.

A plurality of coupling portions may be disposed at four corners of the pump housing 1121, and the plurality of coupling portions may be disposed at four corners of the pump mounting portion 1112, and coupling holes may be disposed at the plurality of coupling portions, respectively. The pump housing 1121 may be screw-coupled to the pump mounting portion 1112 with a plurality of screws.

The pumping blade may be rotatably provided inside the pump housing 1121 to pump oil flowing into the pump housing 1121 through the pump inlet port and discharge oil into the heat exchange cell 115 through the pump discharge port.

When the pumping motor is operated, the oil pump 112 may suck oil through the oil inlet port 123 and flow it into the pump housing 1121, and then pump oil through the rotation of a pumping blade to discharge it into the first heat exchange cell 1151 through the cell inlet port 1151a.

Referring to FIG. 5, oil introduced through the cell inlet port 1151a moves along a counterclockwise direction by the oil pump 112 in the order of the first heat exchange cell 1151 to fifth heat exchange cell 1155 (from the bottom to the top in FIG. 5). In each of the plurality of heat exchange cells 115, oil moves in a zigzag pattern along a length direction (a left-right direction in FIG. 5) of the motor housing 100.

After moving to the fifth heat exchange cell 1155, it may flow out into an upper inner side of the inner housing 120 through a plurality of cell outlet holes disposed on a bottom surface of the fifth heat exchange cell 1155. The plurality of cell outlet holes may be spaced apart along a front-rear direction (a left-right direction in FIG. 5) of the fifth heat exchange cell 1155, and disposed to communicate with an inner side of the inner housing 120.

In this embodiment, it is shown that the first cooling passage 114 is configured as one piece.

Meanwhile, in another embodiment, a plurality of first cooling passages 114 may be disposed at each of front and rear half portions of the outer housing 110 along a length direction of the motor housing 100. The plurality of first cooling passages 114 may be partitioned by partition walls 116 extending along a circumferential direction.

Here, a communication hole may be disposed at the partition wall 116 that traverses the first heat exchange cell 1151 along a circumferential direction, and oil may move from the rear half portion to the front half portion of the first heat exchange cell 1151 through the communication hole, and rise in a zigzag pattern to the fifth heat exchange cell 1155 in both directions along a circumferential direction, and flow out through the cell outlet holes disposed at each of front and rear half portions of the fifth heat exchange cell 1155.

The inner housing 120 may be press-fitted and coupled to an inner circumferential surface of the outer housing 110.

The inner housing 120 may be configured in a cylindrical shape having a hollow portion therein. The inner housing 120 may be disposed to be open in an axial direction. The inner housing 120 may be disposed to have an outer diameter equal to an inner diameter of the inner housing 120.

The stator and the rotor may be disposed in a hollow portion of the inner housing 120. The stator core may be press-fitted and coupled to the inner housing 120.

A plurality of second cooling passages 124 may be provided inside the inner housing 120.

The plurality of second cooling passages 124 may extend in a direction crossing the first cooling passage 114.

Each of the plurality of second cooling passages 124 may be disposed to extend along a circumferential direction.

The plurality of second cooling passages 124 may be arranged to be spaced apart along a length direction of the inner housing 120. The plurality of second cooling passages 124 may be partitioned by a plurality of passage formation portions 125.

Each of the plurality of passage formation portions 125 may protrude in a radially outward direction from an outer circumferential portion of the inner housing 120, and each of the plurality of second cooling passages 124 may be open in a radially outward direction of the inner housing 120. An open portion of the plurality of second cooling passages 124 may be configured to be covered by an inner wall of the outer housing 110 to guide a flow direction of coolant along an circumferential direction.

Each of the plurality of passage formation portions 125 may extend along a circumferential direction. The plurality of passage formation portions 125 may have an outer diameter that is the same as an inner diameter of the outer housing 110 and press-fitted and coupled to an inner side of the outer housing 110.

According to this configuration, as the outer housing 110 and the inner housing 120 share one boundary wall without having an inner wall of the first cooling passage 114 and an outer wall of the second cooling passage 124 to overlap in a radial direction, a radial thickness of the motor housing 100 may be reduced, and as a thickness of the boundary wall is reduced, heat loss during heat exchange between water and oil may be minimized, and heat exchange efficiency may be improved.

A plurality of O-ring 1251 grooves may be arranged at front and rear end portions of the inner housing 120. O-rings 1251 may be provided in each of the O-ring 1251 grooves, and the O-rings 1251 may maintain watertightness between the inner housing 120 and the outer housing 110.

An end ring portion 121 may be further provided at a front or rear end portion of the inner housing 120. The end ring portion 121 may be disposed to have the same outer diameter and inner diameter as those of the outer housing 110. The end ring portion 121 may be disposed to protrude radially outward from an outer circumferential portion of the inner housing 120, and provided to cover an open front or rear end portion of the plurality of heat exchange cells 115.

A bridge 126 may extend at the center of a upper end of the inner housing 120 along a length direction. The bridge 126 may be disposed to protrude radially outward from an outer circumferential portion of the inner housing 120. Injection holes 1261 may be arranged at front and rear end portions of the bridge 126, respectively, to pass therethrough in a radial direction.

An upper end of the injection hole 1261 may be connected to communicate with a cell outlet port 1155a, and a lower end thereof may be disposed to communicate with an inner side of the inner housing 120. An outlet (lower end) of the injection hole 1261 may be configured to face an end turn of the stator coil.

The end turn refers to both end portions of the stator coil protruding from a slot of the stator core, and is configured in a structure in which coil segments (for example, bent portions of hairpins) are bent in opposite directions to be wound toward the next slot from both ends of the stator coil.

A coolant inlet port 1131 and a coolant outlet port 1132 may be disposed in the left semicircular portion 113 of the outer housing 110. Coolant may flow into the second cooling passage 124 through the coolant inlet port 1131. The coolant may flow out of the motor housing 100 from the second cooling passage 124 through the coolant outlet port 1132.

The coolant inlet port 1131 and the coolant outlet port 1132 may be connected to a coolant cooling system.

The coolant cooling system may be connected to a radiator of a vehicle. The radiator is a device that dissipates heat generated from the vehicle by being brought into contact with air outside the vehicle. For example, the radiator is disposed in front of the vehicle to allow outside air to flow into the radiator when driving the vehicle.

The radiator is provided with a heat exchange pipe configured to flow coolant therein to exchange heat between outside air and coolant through the heat exchange pipe.

The coolant cooling system may further include a radiator, a coolant connection pipe connecting the coolant inlet port 1131 and the coolant outlet port 1132, and a circulation pump for circulating coolant, and coolant discharged from the coolant outlet port 1132 may dissipate heat from the radiator and then flow into the second cooling passage 124 again through the coolant inlet port 1131.

The coolant inlet port 1131 and the coolant outlet port 1132 must be partitioned so as to be separated from each other in the second cooling passage 124 disposed along a circumferential direction. This is to prevent coolant flowing in through the coolant inlet port 1131 from flowing out to the coolant outlet port 1132 without heat exchange.

The coolant inlet port 1131 and the coolant outlet port 1132 may be spaced apart from each other along a circumferential direction of the motor housing 100. A passage guide 127 spaced apart from the bridge 126 of the inner housing 120 in a counterclockwise direction may extend along a length direction of the inner housing 120 to cross between the coolant inlet port 1131 and the coolant outlet port 1132.

The passage guide 127 may be disposed to protrude radially outward from an outer circumferential portion of the inner housing 120 so as to be brought into contact with an inner surface of the left semicircular portion 113 of the outer housing 110. The passage guide 127 may block coolant flowing in through the coolant inlet port 1131 from directly moving to the coolant outlet port 1132, thereby preventing it from flowing out to the coolant outlet port 1132 without heat exchange.

In other words, coolant flowing in through the coolant inlet port 1131 is configured to rotatably move in a clockwise direction along the second coolant passage.

A connection hole 1262 may be disposed at a lower portion of the bridge 126 to pass therethrough along a circumferential direction, thereby allowing the coolant inlet port 1131 and the second cooling passage 124 to communicate with each other through the connection hole 1262. The connection hole 1262 may extend along a length direction of the bridge 126.

An inlet-side common header 1281 may be disposed between the passage guide 127 and one end portion of the second cooling passage 124 (spaced apart from the bridge 126 in a clockwise direction). The inlet-side common header 1281 is configured to distribute coolant flowing in through the coolant inlet port 1131 to the plurality of second cooling passages 124.

The inlet-side common header 1281 may be disposed on the left and right sides with the bridge 126 interposed therebetween. Two inlet-side common headers 1281 respectively disposed on the left and right sides are communicated by the connection hole 1262 to move coolant from left to right through the connection hole 1262.

An outlet-side common header 1282 may be disposed between the passage guide 127 and the other end portion of the second cooling passage 124 (spaced apart from the flow guide 127 in a counterclockwise direction). The outlet-side common header 1282 is configured to collect coolant moving in a clockwise direction along the second cooling passage 124 to discharge it to the coolant outlet port 1132.

The inlet-side common header 1281 and the-outlet-side common header 1282 may be disposed to extend along a length direction of the inner housing 120.

The operation of a cooling system of the electric motor 10 according to this configuration will be described.

In the present embodiment, a direct cooling method using oil and an indirect cooling method using coolant may be applied in combination.

Referring first to the direct cooling method using oil with reference to FIG. 5, oil may be supplied with circulation power from the oil pump 112 and introduced into the first heat exchange cell 1151 located at the lowermost end of the outer housing 110 through the cell inlet port 1151a.

Oil may move from a rear end portion (a right end portion in the drawing) to a front side (a left side in the drawing) of the outer housing 110 by a first partition wall 1161, 116 in the first heat exchange cell 1151, and move to a second heat exchange cell 1152 located second from a lower end in a counterclockwise direction through a first communication passage 1171 disposed at a front end portion of the first heat exchange cell 1151.

The oil may move from a front end of the outer housing 110 toward the rear side by a second partition wall 1162, 116 in the second heat exchange cell 1152, and move to a third heat exchange cell 1153 located third from a lower end in a counterclockwise direction through the second communication passage 1172 disposed at a rear end portion of the second heat exchange cell 1152.

Subsequently, the oil may move from a rear end portion of the outer housing 110 toward the rear side by a third partition wall 1163, 116 in the third heat exchange cell 1153, and move to a fourth heat exchange cell 1154 located fourth from a lower end in a counterclockwise direction through a third communication passage 1173 disposed at a front end portion of the third heat exchange cell 1153.

Subsequently, the oil may move toward a rear side of the outer housing 110 by a fourth partition wall 1164, 116 in the fourth heat exchange cell 1154, and is formed at the rear end of the fourth heat exchange cell 1154, and move to a fifth heat exchange cell 1155 located at the upper end in a counterclockwise direction through a four communication passage 1174.

Subsequently, the oil flows out downward through the cell outlet port 1155a in the fifth heat exchange cell 1155, and flows out into an inner space of the inner housing 120 through the injection hole 1261 communicated with the cell outlet port 1155a to be directly injected to an end turn of the stator coil.

The oil injected to the end turn may directly cool the stator and rotor by moistening not only the stator coil but also the stator core, rotor and rotation shaft around the stator coil.

Cooling efficiency and cooling performance may be improved by injecting oil directly to the stator coil.

Oil may be cooled by coolant while moving in a zigzag pattern along a front-rear direction of the motor housing 100 from the first heat exchange cell 1151 to the fifth heat exchange cell 1155.

Accordingly, oil may be cooled by coolant to absorb more heat from the motor housing 100. The motor housing 100 may be in contact with an outer circumferential portion of the stator core.

In other words, an inner circumferential surface of the inner housing 120 may be brought into contact with an outer circumferential portion of the stator core, and the passage formation portion 125, the passage guide 127, the bridge 126, and the like, of the inner housing 120 may be brought into contact with an inner wall of the outer housing 110 to transfer heat generated from the stator core from an inner wall of the inner housing 120 to the outer housing 110 through the passage formation portion 125, the passage guide 127, and the bridge 126, and transfer heat from the outer housing 110 to oil.

In FIG. 6, coolant flowing into the inlet-side common header 1281 through the coolant inlet port 1131 may move along a front-rear direction of the inner housing 120 by the passage guide 127 from the inlet-side common header 1281.

Subsequently, the coolant may receive power from the coolant circulation pump to move clockwise and pass through the connection hole 1262, and may be distributed to a plurality of second cooling passages 124 by the plurality of passage formation portions 125.

Subsequently, the coolant moves clockwise along the plurality of second cooling passages 124, and moves to the outlet-side common header 1282 located at an upper end of the other side of the second cooling passage 124 through a lower end of the inner housing to be collected.

The coolant collected in the outlet-side common header 1282 may flow out through the coolant outlet port 1132 located in the middle along an axial direction of the inner housing 120 along a front-rear direction of the inner housing 120 by the passage guide 127.

The coolant exchanges heat with the oil flowing along the first cooling passage 114 of the outer housing 110 while flowing along the second cooling passage 124 of the inner housing 120.

The coolant may flow in a direction crossing the flow direction of the oil, thereby improving heat exchange performance between the coolant and the oil.

According to a temperature difference between the coolant and the oil, heat may be transferred from the oil to the coolant. The coolant may be cooled by heat exchange with air in the radiator and then returned to the motor housing 100.

As a result, according to the present disclosure, a plurality of injection ports for injecting oil directly to a stator coil from an upper portion of a housing may be provided to directly cool a motor, thereby improving cooling efficiency and cooling performance.

Furthermore, the first cooling passage 114 disposed at an outer side of the housing to flow oil and the second cooling passage 124 disposed at an inner side of the housing to flow coolant and exchange heat with the first cooling passage 114 may be provided to cool the oil by the coolant while flowing along the first cooling passage 114 until being transferred to an injection port at an upper portion of the housing, thereby simplifying the structure of a cooling system of the motor because an outer passage of a heat exchange system for exchanging heat with oil is not additionally required.

In addition, a complex cooling passage structure in which oil cooling and water cooling are performed at the same time may be provided to further increase cooling performance, thereby being used to cool a motor for driving a vehicle of 50 kW or higher.

Moreover, the oil pump 112 and the motor housing 100 may be integrally coupled to each other to downsize the motor, thereby increasing a degree of design freedom when the motor is mounted on a vehicle.

Besides, inside and outside of the motor housing 100 may be composed of two pieces, thereby facilitating the molding of a double cooling passage.

Furthermore, an internal passage of the motor may be provided with a multi-pass passage structure to efficiently maintain flow in a circumferential direction, thereby minimizing flow resistance.

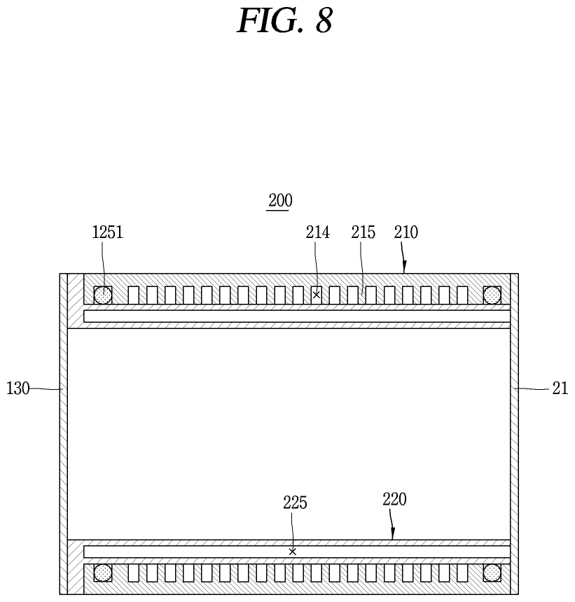

FIG. 8 is a cross-sectional view of a motor housing 200 showing a structure of a dual cooling passage according to a second embodiment of the present disclosure.

The motor housing 200 according to a second embodiment may include an outer housing 210 and an inner housing 220. The dual cooling passages may include a plurality of first cooling passages 214 disposed inside the outer housing 210 and a second cooling passage disposed inside the inner housing 220.

Each of the plurality of first cooling passages 214 may extend in a circumferential direction inside the outer housing 210, and the plurality of first cooling passages 214 may be spaced apart along a length direction of the outer housing 210 by the plurality of passage formation portions 2151.

The second cooling passage may include a plurality of heat exchange cells 225 extending in a length direction inside the inner housing 220 and a plurality of communication passages connecting the plurality of heat exchange cells 225.

The plurality of communication passages may be alternately disposed at front and rear end portions of the inner housing 220 while moving along a circumferential direction.

Oil may receive power from the oil pump to move in a circumferential direction along the plurality of first cooling passages 214 from a lower end portion of the outer housing 210 toward an upper end portion thereof.

Coolant may receive power from the circulation pump to move from an upper portion of the inner housing 220 along the second cooling passage in a zigzag pattern along a length direction of the inner housing 220. The coolant may move between a plurality of heat exchange cells 225 adjacent in a circumferential direction through a plurality of communication passages.

The oil may flow along the first cooling passage 214 of the outer housing 210, and the coolant may flow along the second cooling passage of the inner housing 220 to exchange heat with each other.

Other components are the same as or similar to those of the first embodiment (see FIGS. 1 to 6) described above, and thus redundant description thereof will be omitted.

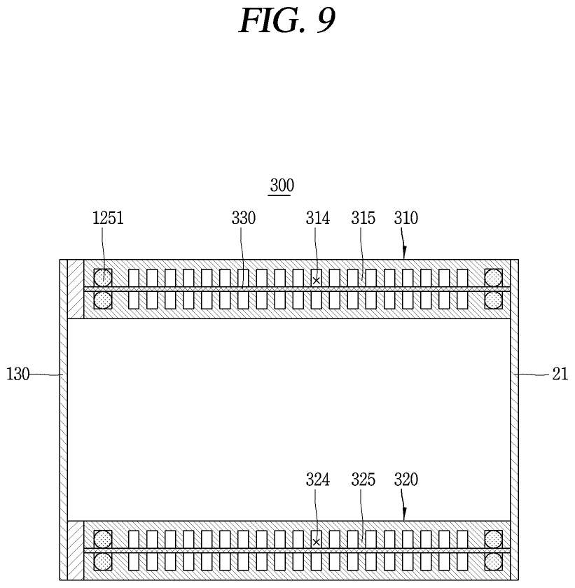

FIG. 9 is a cross-sectional view of a motor housing 300 showing a structure of a dual cooling passage according to a third embodiment of the present disclosure.

The motor housing 300 according to a third embodiment may include an outer housing 310 and an inner housing 320.

The dual cooling passages may include a plurality of first cooling passages 314 disposed inside the outer housing 310 and a second cooling passage 324 disposed inside the inner housing 320.

Each of the plurality of first cooling passages 314 may extend in a circumferential direction inside the outer housing 310, and the plurality of first cooling passages 314 may be spaced apart along a length direction of the outer housing 310 by the plurality of passage formation portions 3151.

The plurality of second cooling passages 324 may also be configured in the same manner as the plurality of first cooling passages 314.

The plurality of first and second cooling passages 324 are disposed to be open toward the inside or the outside along the same direction, for example, in a radial direction, and an intermediate housing 330 may be interposed between the outer housing 310 and the inner housing 320.

The intermediate housing 330 is configured to block an open portion of the first cooling passage 314 or the second cooling passage 324 to prevent oil and coolant from being mixed with each other. The intermediate housing 330 may be configured in a cylindrical tube shape having a hollow portion therein.

The oil may flow along the first cooling passage 314 of the outer housing 310, and the coolant may flow along the second cooling passage 324 of the inner housing 320 to exchange heat with each other.

In the above-described embodiment, an example in which oil flows along the first cooling passage 314 inside the outer housing 310 and coolant flows along the second cooling passage 324 inside the inner housing 320 has been described, but on the contrary, it may also be configured such that coolant flows inside the outer housing 310 and oil flows inside the inner housing 320.

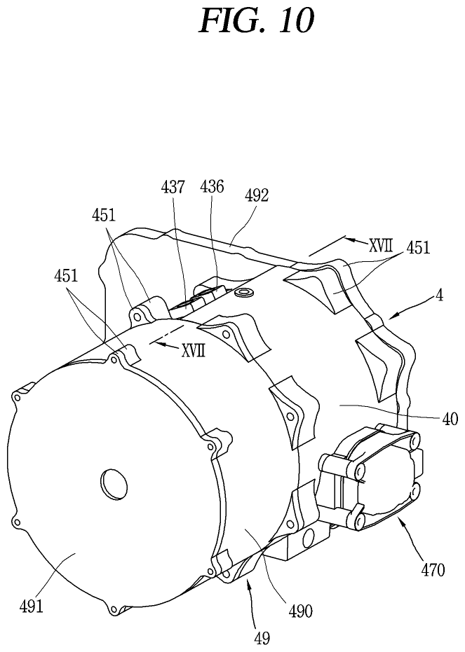

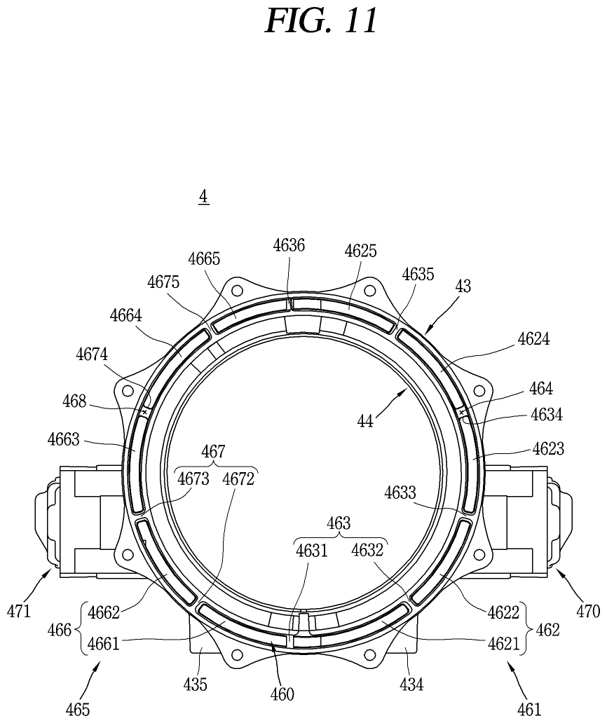

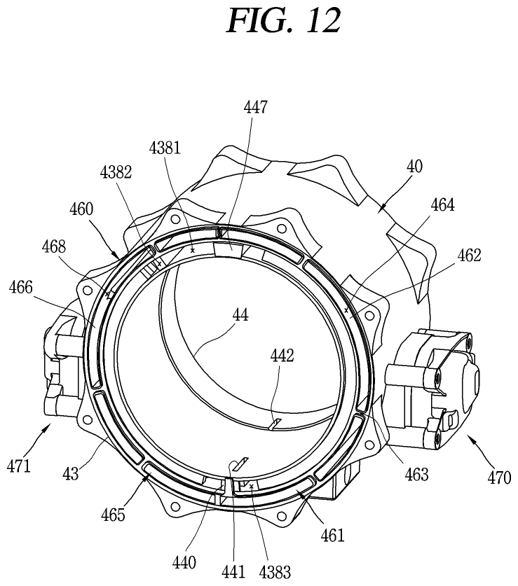

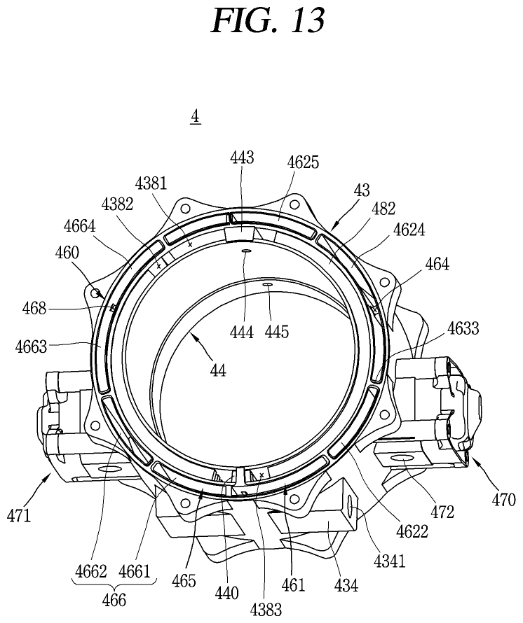

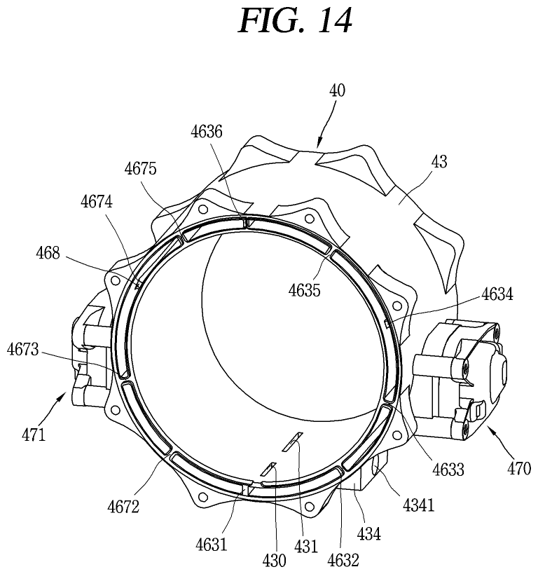

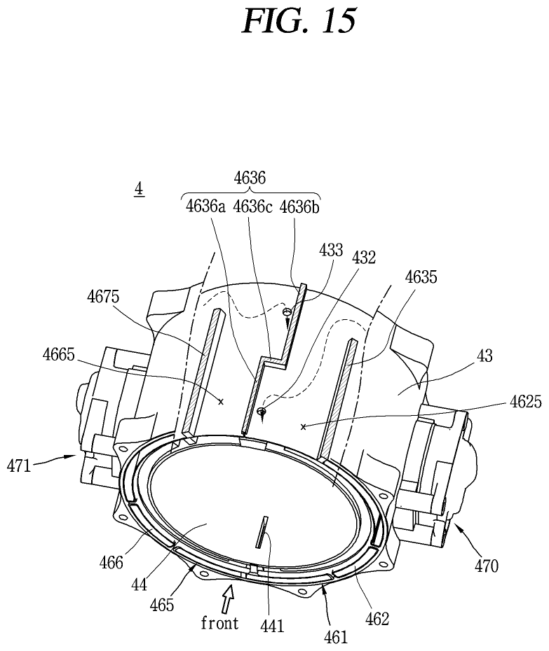

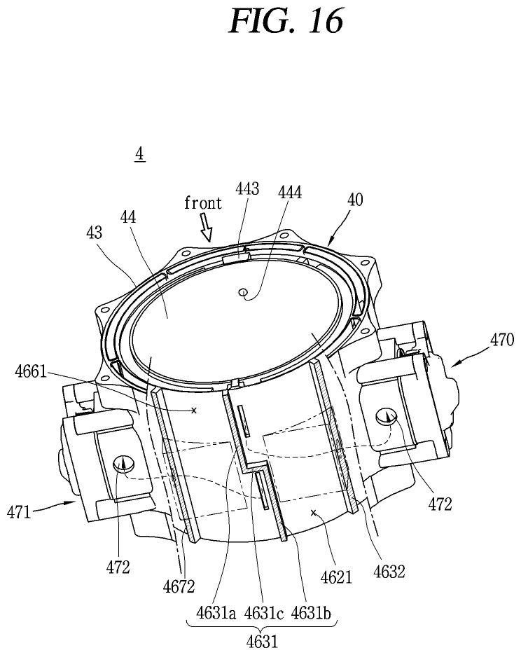

FIG. 10 is a perspective view of a drive system for an electric vehicle according to a fourth embodiment of the present disclosure. FIG. 11 is a front view showing a state in which a bidirectional oil pump according to a fourth embodiment of the present disclosure is mounted on a motor housing 30. FIG. 12 is a perspective view showing a state in which a plurality of oil inlet ports 341, 342 are arranged at a lower portion of an inner housing 34 in FIG. 11. FIG. 13 is a bottom view showing a state in which a plurality of injection nozzles 344, 345 are arranged at an upper portion of the inner housing 34 in FIG. 11. FIG. 14 is a perspective view showing an outer housing 33 after removing the inner housing 34 in FIG. 12. FIG. 15 is a partially cut-away bottom perspective view for explaining a plurality of oil inlet ports 341, 342 disposed at a lower portion of the outer housing 33 in FIG. 14. FIG. 16 is a partially cut-away perspective view for explaining a plurality of injection nozzles 344, 345 disposed at an upper portion of the outer housing 33 in FIG. 14.

A drive system of an electric vehicle includes an electric motor 4 for rotating a wheel of a vehicle, and an inverter 49 for driving the electric motor 4. The electric motor 4 and the inverter 49 may be configured integrally with each other.

The inverter 49 includes an inverter housing 490 in which electronic components such as IGBT switching elements are mounted therein.

The electric motor 4 includes a motor housing 40 in which a stator 41, a rotor and the like are provided.

The stator 41 may include a stator core 410 and a stator coil 411 wound around the stator core 410.

The rotor is composed of a rotor core 420 and a permanent magnet, and may be provided inside the stator core 410 so as to be rotatable about the rotation shaft 421 with respect to the stator 41.

The stator core 410 may be accommodated in an inner space of the motor housing 40. In an inner circumferential portion of the stator core 410, a plurality of slots may extend along a radial direction, and the plurality of slots may be spaced apart from each other in a circumferential direction.

The inverter housing 490 and the motor housing 40 are respectively in a cylindrical shape, and the inverter housing 490 is open forward along a length direction, and the motor housing 40 is open in a front-rear direction along the length direction.

A front cover 491 is provided at a front side of the inverter housing 490 to cover the opening portion of the inverter housing 490.

A rear cover 450 is provided at a rear side of the motor housing 40 to cover the opening portion of the motor housing 40.

A rear cover 492 may extend in a radial direction from a rear end portion of the inverter housing 490, and the rear cover 492 is configured to cover a rear side of the inverter housing 490, and partition the inverter housing 490 and the motor housing 40.

The front cover 491, the inverter housing 490, the motor housing 40, and the rear cover 450 may define an appearance of the drive system, and each includes a plurality of fastening portions 451 spaced apart along a circumferential direction. Each of the plurality of fastening parts 451 is arranged to correspond to each other in a length direction, and configured to fasten the front cover 491, the inverter housing 490, the motor housing 40, and the rear cover 450 along the length direction.

The electric motor 4 according to an embodiment includes a dual passage disposed inside the motor housing 40 and a plurality of oil pumps 470, 471 for circulating oil.

The dual passage may include a first cooling passage 460 and a second cooling passage 480 inside the motor housing 40. The first cooling passage 460 may be configured to allow oil to flow therein, and the second cooling passage 480 may be configured to allow coolant to flow therein.

The motor housing 40 may include an outer housing 43 and an inner housing 44. A first cooling passage 460 may be disposed inside the outer housing 43, and a second cooling passage 480 may be disposed inside the inner housing 44.

The outer housing 43 may be defined in a cylindrical shape extending along a circumferential direction at an outer side of the motor housing 40.

The inner housing 44 may be defined in a cylindrical shape extending along a circumferential direction with a diameter smaller than that of the outer housing 43. The inner housing 44 may be coupled to an inner side of the outer housing 43 in a press-fitted manner.

The first cooling passage 460 may include a first oil passage 461 and a second oil passage 465. A plurality of oil pumps 470, 471 may be provided in the motor housing 40 to circulate oil along the first cooling passage 460.

The plurality of oil pumps 470, 471 may include a first oil pump 470 and a second oil pump 471 assembled on both side surfaces of the motor housing 40 and mounted integrally.

The first oil pump 470 is disposed on the right side with respect to an imaginary line passing through the center of the motor housing 40 in a radial direction to circulate oil in a counterclockwise direction along the first oil passage 461. have.

The second oil pump 471 is disposed on the left side of the motor housing 40 and may be configured to circulate oil in a clockwise direction along the second oil passage 465.

The first oil passage 461 and the second oil passage 465 may be configured by dividing the left and right sides of the motor housing 40 on the same circumference by half.

The first oil passage 461 may extend in a counterclockwise direction from the right side based on an imaginary line passing through the center of the motor housing 40 in a radial direction. The second oil passage 465 may extend in a clockwise direction from the left side with respect to the imaginary line.

The first oil passage 461 may include a first heat exchange cell 4621 to an m-th heat exchange cell extending along a length direction of the motor housing 40; plurality of partition walls 463 partitioning the first heat exchange cell 4621 to the m-th heat exchange cell to be spaced apart from each other in a circumferential direction; and a communication hole 464 disposed at a front or rear end portion of the plurality of partition walls 463 extending along a length direction of the motor housing 40 to communicate two adjacent heat exchange cells 462 with each other along the circumferential direction.

The second oil passage 465 may include a first heat exchange cell 4671 to an n-th heat exchange cell extending along a length direction of the motor housing 40; a plurality of partition walls 467 partitioning the first heat exchange cell 4671 to the n-th heat exchange cell to be spaced apart from each other in a circumferential direction; and a communication hole 468 disposed at a front or rear end portion of the plurality of partition walls 467 extending along a length direction of the motor housing 40 to communicate two adjacent heat exchange cells 466 with each other along the circumferential direction.

The plurality of heat exchange cells 462, 466 disposed in each of the first oil passage 461 and the second oil passage 465 may include a first heat exchange cell 4621, 4661 to a fifth heat exchange cell 4625, 4665. The first heat exchange cell 4621 of the first oil passage 461 may be disposed at the lowermost end portion of the motor housing 40, and the fifth heat exchange cell 4625 of the first oil passage 461 may be disposed at the uppermost end portion of the motor housing 40.

The first heat exchange cell 4661 of the second oil passage 465 may be disposed at the lowermost end portion of the motor housing 40, and the fifth heat exchange cell 4665 of the second oil passage 465 may be disposed at the uppermost end portion of the motor housing 40.

The plurality of heat exchange cells 462, 466 may be applied to the first oil passage 461 and the second oil passage 465, respectively, in a symmetrically similar manner.

The total number of partition walls 463 spaced apart along a circumferential direction of the motor housing 40 is 10, but each of the first oil passage 461 and the second oil passage 465 may share the first partition wall 4631 disposed at the lowermost end of the motor housing 40 and the sixth partition wall 4636 disposed at the uppermost end of the motor housing 40, and thus each of the first and the second oil passage 362, 365 may include the first partition wall 4631 to the sixth partition wall 4636 from the lowermost end to the uppermost end of the semicircle.

The first heat exchange cell 4621 of the first oil passage 461 and the first heat exchange cell 4661 of the second oil passage 465 may be partitioned by a partition wall 4636 located at the lowermost end of the partition wall 463 of the first cooling passage 460.

The first partition wall 4631 disposed between the first heat exchange cell 4621 of the first oil passage 461 and the first heat exchange cell 4661 of the second oil passage 465 may include a front partition wall 4631a extending along a length direction at a front side of the motor housing 40; a rear partition wall 4631b alternately extending in a length direction to the front partition wall 4631a at a rear side of the motor housing 40 in the length direction; and a connection partition wall 4631c that connects a rear end portion of the front partition wall 431a and a front end portion of the rear partition wall 431b spaced apart from each other in a circumferential direction. The connection partition wall 4631c may extend in a circumferential direction.

The second partition wall 4632 of the first oil passage 461 extends in a length direction from a front end to a rear end of the motor housing 40, and a circumferential distance between the front partition wall 4631a of the first partition wall 4631 of the first oil passage 461 and the second partition wall 4332 is larger than a circumferential distance between the rear partition wall 4631b and the second partition wall 4632.

A front half portion of the first heat exchange cell 4621 of the first oil passage 461 may be disposed to have a larger circumferential length than a rear half portion thereof, and a front half portion of the first heat exchange cell 4661 of the second oil passage 465 may be disposed to have a larger circumferential length than a rear half portion thereof.

A plurality of oil inlet ports 441, 442 may be disposed on a bottom surface of the inner housing 44. The plurality of oil inlet ports 441, 442 may extend along a length direction to front and rear half portions of the inner housing 44, respectively.

The first oil inlet port 441 between the plurality of oil inlet ports 441, 442 may be disposed to communicate with a front half portion of the first heat exchange cell of the first oil passage 461.

The second oil inlet port 442 between the plurality of oil inlet ports 441, 442 may be disposed to communicate with a rear half portion of the first heat exchange cell 4661 of the second oil passage 465.

The plurality of oil inlet ports 441, 442 may be spaced apart in a straight line along a length direction of the motor housing 40.

A first protruding portion 440 protruding along a radial direction may be disposed on a bottom surface of the inner housing 44. The first protruding portion 440 may have a predetermined width and may extend along a length direction of the motor housing 40. The plurality of oil inlet ports 441, 442 may be disposed to pass through the first protrusion 440 in a height direction.

A plurality of oil communication holes 330, 331 may be disposed to pass through the outer housing 43 so as to correspond to the plurality of oil inlet ports 441, 442, and the plurality of oil inlet ports 441, 442 may communicate with the first heat exchange cells 4621,4661 of the first oil passage 461 and the second oil passage 465 through the plurality of oil communication holes 330, 331.

In the present embodiment, the first oil communication hole 430 may communicate with the first oil inlet port 441 and the second oil communication hole 431 may communicate with the second oil inlet port 442.

The fifth heat exchange cell 4625 of the first oil passage 461 and the fifth heat exchange cell 4665 of the second oil passage 465 may share the sixth partition wall 4636 disposed at the uppermost end of the partition wall 463 of the first cooling passage 460, and may be configured in the same manner as the forgoing first partition wall 4631.

According to this configuration, part of each of the fifth heat exchange cell 4625 of the first oil passage 461 and the fifth heat exchange cell 4665 of the second oil passage 465 may be disposed to overlap each other along a length direction of the motor housing 40.

The plurality of injection nozzles 444, 445 may be disposed to pass through an upper portion of the motor housing 40 in a radial direction. Each of the plurality of injection nozzles 444, 445 may be spaced apart from each other in a length direction of the motor housing 40. Each of the plurality of injection nozzles 444, 445 may be defined in a circular cross-sectional shape.

The outer housing 43 may be configured with a double wall. A first wall may have a predetermined thickness to define an outer circumferential surface of the outer housing 43, and a second wall has a predetermined thickness to define an inner circumferential surface of the outer housing 43.

The partition wall 463 may extend in a radial direction between the first and second walls.

The plurality of injection nozzles 444, 445 may include a first injection nozzle 444 and a second injection nozzle 445.

The first injection nozzle 444 may be disposed in a front half portion of the motor housing 40, and the second injection nozzle 445 may be disposed in a rear half portion of the motor housing 40 to inject oil to an end coil of the stator coil 411. The end coil refers to the stator coil 411 protruding from the slot of the stator core 410 in both axial directions.

The first injection nozzle 444 may include a first oil outlet hole 432 disposed at a front half portion of the fifth heat exchange cell 4625 of the first oil passage 461 to pass therethrough in a height direction, and a first oil injection port 4441 disposed at a front half portion of the second protruding portion 443 configured to communicate with the first oil outlet hole 432 and located at the uppermost end of the inner housing 44 to pass therethrough in a height direction.

The second injection nozzle 445 may include a second oil outlet hole 433 disposed at a rear half portion of the fifth heat exchange cell 4625 of the second oil passage 465 to pass therethrough in a height direction, and a second oil injection port 4451 configured to communicate with the second oil outlet hole 433 and disposed at a rear half portion of the second protruding portion 443 to pass therethrough in a height direction.

A plurality of oil pumps 470, 471 may be mounted on both side surfaces of the outer housing 43.

The plurality of oil pumps 470, 471 may include a first oil pump 470 mounted on a right side surface of the outer housing 43 and a second oil pump 471 mounted on a left side surface of the outer housing 43.

Each of the first and second oil pumps 470, 471 may include a plurality of blades rotatably provided inside the pump housing, and a pumping motor driving the plurality of blades. As the pumping motor is operated, the plurality of blades may rotate together.

A first suction portion 434 for sucking oil from the first heat exchange cell 4621 of the first oil passage 461 to the first oil pump 470 may be disposed to extend in a tangential direction. A first suction hole 441 may be disposed inside the first suction portion 434.

One side of the first suction hole 4341 may be connected in communication with the first heat exchange cell 4621 of the first oil passage 461, and the other side of the first suction hole 4341 may be connected in communication with a suction port 472 of the first oil pump 470. The other side of the first suction hole 4341 and the suction port 472 of the first oil pump 470 may be connected by a first connection hose or an elbow-shaped first pipe.

A second suction portion 435 for sucking oil from the first heat exchange cell 4621 of the second oil passage 465 to the second oil pump 471 may be disposed to extend in a tangential direction. A second suction hole 4351 may be disposed inside the second suction portion 435.

One side of the second suction hole 4351 may be connected in communication with the first heat exchange cell 4621 of the first oil passage 465, and the other side of the second suction hole 4351 may be connected in communication with a suction port 472 of the second oil pump 471. The other side of the second suction hole 4351 and the suction port 472 of the second oil pump 471 may be connected by a second connection hose or an elbow-shaped second pipe.

The first heat exchange cell 4621 and the second heat exchange cell 4622 of the first oil passage 461 may be partitioned from each other by the second partition wall 4632, and unlike two other heat exchange cells 462 adjacent to each other in a circumferential direction, the communication hole 464 may not be disposed between the first heat exchange cell 4621 and the second heat exchange cell 4622.

The second partition wall 4632 between the first heat exchange cell 4621 and the second heat exchange cell 4622 of the first oil passage 461 has the same length as that of the motor housing 40, and a length of the third partition walls 4663 to the fifth partition walls 4635 between the other heat exchange cells 462 is smaller than that of the outer housing 43 by a length of the communication hole 464.

The same applies to the second partition wall 4632 between the first heat exchange cell 4621 and the second heat exchange cell 4622 of the second oil passage 465. According to this configuration, when oil is sucked from the second heat exchange cell 4622, the pressure loss of the oil may be reduced.

The second heat exchange cells 4622,4662 disposed adjacent to each other in a circumferential direction from the first heat exchange cells 4621,4661 of each of the first oil passage 461 and the second oil passage 465 may be disposed to communicate with the discharge portions of the oil pump 470, 471 to discharge oil pumped by the oil pumps 470, 471 to the second heat exchange cell 4622. The discharge portions of the oil pumps 470, 471 may be disposed inside the pump housing to pass therethrough toward the second heat exchange cell 4622.

The second cooling passage 480 disposed to flow coolant inside the inner housing 44 may include a plurality of coolant channels 481. The plurality of coolant channels 481 may extend along a circumferential direction of the inner housing 44. The plurality of coolant channels 481 may be spaced apart from each other along a length direction of the inner housing 44. The plurality of coolant channels 481 may be defined by a plurality of passage formation portions 482.

The plurality of passage formation portions 482 may extend along a circumferential direction of the inner housing 44. The plurality of passage formation portions 482 may be spaced apart from each other along a length direction of the inner housing 44.

The plurality of coolant channels 481 and the plurality of passage formation portions 482 may be alternately disposed along a length direction while alternating with each other. The plurality of coolant channels 481 may be configured to open upward and be covered by an inner circumferential surface of the outer housing 43.

A coolant inlet port 436 may be disposed at one side of the outer housing 43. A coolant outlet port 437 may be disposed at the other side of the outer housing 43. The coolant inlet port 436 and the coolant outlet port 437 may be connected to a coolant circulation system.

A plurality of common headers may be disposed at an upper portion of the inner housing 44. One of the plurality of common headers may be an inlet-side common header 4831 and the other one thereof may be an outlet-side common header 4832.

An intermediate common header 4833 may be disposed at a lower portion of the inner housing 44, and coolant moving along the plurality of coolant channels 481 from the inlet-side common header 4831 may gather briefly at the intermediate common header 4833 and then move along the other one of the plurality of coolant channels 481 extending circumferentially toward the outlet-side common header 4832.

The coolant inlet port 436 and the coolant outlet port 437 may be disposed to pass through the outer housing 43 to communicate with the inlet-side common header 4831 and the outlet-side common header 4832. The inlet-side common header 4831 and the outlet-side common header 4832 may be partitioned from each other by a partition wall (not shown).

A coolant circulation system may include a radiator, a coolant circulation line, and a water pump. The radiator may serve to inhale outside air to cool the coolant. The coolant circulation line may be connected to the coolant inlet port 436 and the coolant outlet port 437 to define a circulation passage for coolant. The water pump may provide circulation power to coolant to circulate the coolant.

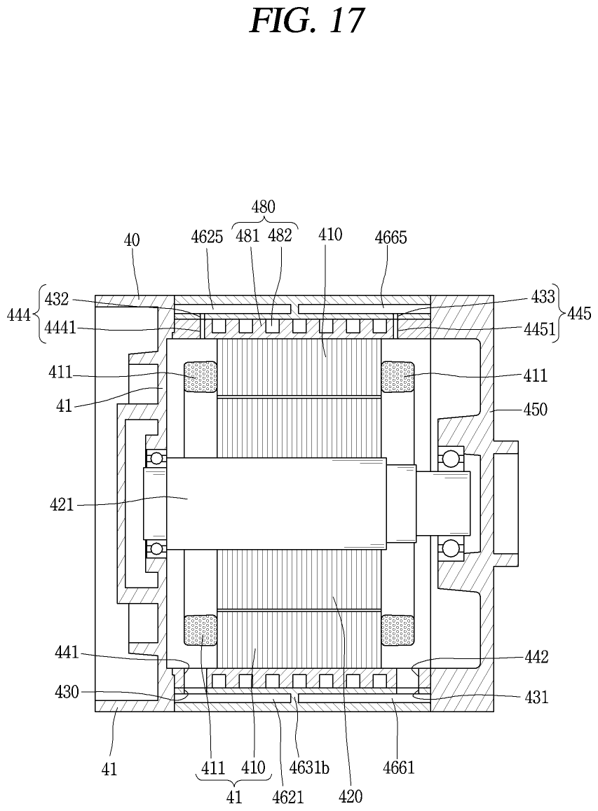

FIG. 17 is a cross-sectional view taken along line XVII-XVII in FIG. 10.

The movement path of coolant is as follows. Coolant cooled by the coolant circulation system may flow into the inlet-side common header 4831 through the coolant inlet port 436. The coolant may be evenly distributed to the plurality of coolant channels 481, which are the second cooling passages 480, by the inlet-side common header 4831.

The coolant may rotate 360 degrees in a circumferential direction (clockwise direction) along the plurality of coolant channels 481 to be collected in the outlet-side common header 4832. The coolant collected in the outlet-side common header 4832 may be discharged to the outside through the coolant outlet port 437, and moved to the coolant circulation system to be cooled, and then may flow back into the coolant inlet port 436.

The movement path of oil is as follows. Oil may be circulated by the oil pumps 470,471. Oil stored inside the motor housing 40 may flow into the first heat exchange cell 4261 of the first oil passage 461 and the first heat exchange cell 4661 of the second oil passage 465 through the first oil inlet port 441 and the second oil inlet port 442, respectively.

The oil flowing into the first heat exchange cells 4621,4661, respectively, is branched in circumferential directions (both directions) opposite to each other by the first and second oil pumps 470,471 to rotationally move to the second heat exchange cells 4622,4662 to the fifth heat exchange cells 4625, 4665.

At this time, the oil may be cooled through heat exchange with coolant in the first cooling passage 460.

The cooled oil may be injected into an inner space of the inner housing 44 through the first and second injection nozzles 445 from the fifth heat exchange cell 4625. The injected cooled oil is sprayed to the end coil to cool the end coil of the stator coil 411 that is a hot spot.

An operation algorithm of the oil pump when driving an electric vehicle is as follows.

During the low-speed and low-torque operation of the vehicle, the controller may cool the electric motor 4 only with coolant by turning off the oil pumps 470, 471 and operating only the water pump.

During high-speed and high-torque operation, the controller may cool the electric motor 4 by turning on the water pump and the first oil pump 470 to circulate coolant and oil at the same time. During high-speed and high-torque operation, the controller may operate both the first oil pump 470 and the second oil pump 471.

When the user proceeds with a zero to hundred manual operation (referring to a time it takes to accelerate from a standstill to 100 km/h), the controller may operate the first oil pump 470 and the second oil pump 471 at the same time to cool the electric motor 4.

When the user operates in an energy saving mode in consideration of a fuel economy operation, the electric motor 4 may be cooled only with coolant by turning off the oil pump and operating only the water pump.

According to the present disclosure, a motor core portion and cooling oil may be cooled while flowing through the second cooling passage 480, which is one of inner passages in a wall body of the motor housing 40, and then heat may be dissipated from a radiator, and then recirculated to the motor housing 40.

Furthermore, the end coil and the rotor may be cooled while flowing through the first cooling passage 460, which is the other one of inner passages in a wall body of the motor housing 40, and then heat may be discharged to coolant while flowing through an inner wall of the motor housing 40, and then recirculated to an inside of the motor housing 40.

According to a dual passage of the present disclosure, heat dissipation by coolant may be performed in a low heating (low power) condition, and heat dissipation by coolant and cooling oil may be performed in a high heating (high output) condition.

Accordingly, compared to a water cooling method in the related art, oil may be directly injected to enhance heat dissipation efficiency, thereby driving the electric motor 4 at a higher output with the same size housing.

Furthermore, according to the present disclosure, compared to an oil cooling method in the related art, an oil cooler may be replaced with the second cooling passage 480 disposed inside the housing wall body, thereby achieving cost reduction and compact structure.

Furthermore, the present disclosure may allow a hybrid operation according to a heating state, thereby having higher efficiency than the oil cooling type in the related art in which the oil pump is operated at all times.

Furthermore, only coolant may be circulated in a low heating condition in which the outside is in a low temperature state, thereby solving reliability problem due to an increase in oil viscosity at a low-temperature state.

Moreover, the temperature of the housing may be maintained lower than that of the oil cooling type in the related art by coolant, thereby improving the lifespan of a bearing.

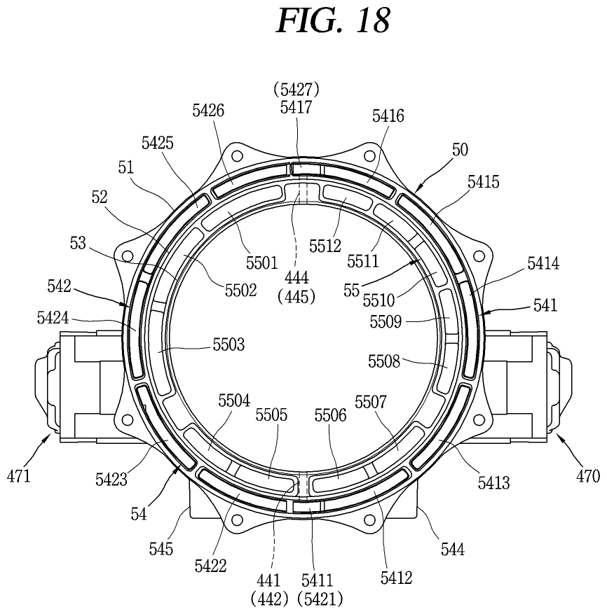

FIG. 18 is a front view showing a dual passage structure of the motor housing 50 according to a fifth embodiment of the present disclosure.

In the present embodiment, the motor housing 50 may be include triple walls 51, 52, 53.

The first wall 51 may define an outer circumferential surface of the motor housing 50, and the second wall 52 may be spaced apart from an inner side of the first wall 51 in a radial direction, and the third wall 53 may be spaced apart from an inner side of the second wall 52 in a radial direction.

A first cooling passage 54 may be disposed between the first and second walls 51, 52, and a second cooling passage 55 is disposed between the second and third walls 52, 53.

The first cooling passage 54 is the same as or similar to the first cooling passage 460 of the first embodiment, and thus redundant description thereof will be omitted.

The first heat exchange cell 5411 of the first oil passage 541 and the first heat exchange cell 5411 of the second oil passage 542 may be disposed in a row with each other in a front-rear direction at the lowermost end of the motor housing 50, and the first heat exchange cell 5411 of the oil passage 541 may be disposed at a front half portion of the motor housing 40 in a length direction thereof, and the first heat exchange cell 5411 of the second oil passage 542 may be disposed at a rear half portion of the motor housing 40 in a length direction thereof.

The first heat exchange cell 5411 of the first oil passage 541 and the first heat exchange cell 5411 of the second oil passage 542 may extend by half the length of the motor housing 50. The first heat exchange cell 5411 of the first oil passage 541 and the first heat exchange cell 5411 of the second oil passage 542 may be partitioned by an intermediate partition wall.

An oil inlet port may be disposed at an upper portion of each of the first heat exchange cell 5411 of the first oil passage 541 and the first heat exchange cell 5411 of the second oil passage 542. The plurality of oil inlet ports 441, 442 may be disposed on an inner bottom surface of the motor housing 40 to be spaced apart in a front-rear direction.

One 441 between the plurality of oil inlet ports 441, 442 may be disposed at a front half portion of the third and second walls 53, 52 of the motor housing 50 to pass therethrough in a thickness direction and may extend along a length direction to communicate with the first heat exchange cell 5411 of the oil passage 541.

The other one 442 between the plurality of oil inlet ports 441, 442 may be disposed at a rear half portion of the third and second walls 53, 52 of the motor housing 50 to pass therethrough in a thickness direction and may extend along a length direction to communicate with the first heat exchange cell 5241 of the oil passage 542.

The second heat exchange cell 5412 of the first oil passage 541 may be adjacently spaced apart from the first heat exchange cell 5411 in a counterclockwise direction, and a first suction portion 544 for sucking oil from the second heat exchange cell 5412 to the first oil pump 470 may be disposed to extend in a tangential direction.

One side of the first suction portion 544 may be connected in communication with the second heat exchange cell 5412 of the first oil passage 541, and the other side of the first suction portion 544 may be connected in communication with a suction port of the first oil pump 470. The other side of the first suction portion 544 and the suction port of the first oil pump 470 may be connected by a first connection hose or an elbow-shaped first pipe.

The second heat exchange cell 5422 of the second oil passage 542 may be adjacently spaced apart from the first heat exchange cell 5421 in a clockwise direction, and a second suction portion 545 for sucking oil from the second heat exchange cell 5422 to the second oil pump 471 may be disposed to extend in a tangential direction.

One side of the second suction portion 545 may be connected in communication with the second heat exchange cell 5422 of the second oil passage 542, and the other side of the second suction portion 545 may be connected in communication with a suction port of the second oil pump 471. The other side of the second suction portion 545 and the suction port of the second oil pump 471 may be connected by a second connection hose or an elbow-shaped second pipe.

The second heat exchange cell 5412 and the third heat exchange cell 5413 of the first oil passage 541 may be partitioned from each other by a partition wall, and unlike two other heat exchange cells 56 adjacent to each other in a circumferential direction, a communication hole may not be disposed between the second heat exchange cell 5412 and the third heat exchange cell 5413.

The partition wall between the second heat exchange cell 5412 and the third heat exchange cell 5413 of the first oil passage 541 has the same length as that of the motor housing 50, and a partition wall between the other heat exchange cells 462 is smaller by the length of the communication hole.

The same applies to a partition wall between the second heat exchange cell 5412 and the third heat exchange cell 5413 of the second oil passage 542. According to this configuration, when oil is sucked from the second heat exchange cell 5412, the pressure loss of the oil may be reduced.

The third heat exchange cell 5413 of the first oil passage 541 may be disposed to communicate with a discharge portion of the oil pump.

Each of the first and second oil pumps 470, 471 may include a plurality of blades rotatably provided inside the pump housing, and a pumping motor driving the plurality of blades. As the pumping motor is operated, the plurality of blades may rotate together.

Oil may flow into the first heat exchange cell 5411 through the oil inlet port, and flow into the pump housing through the suction portion 544, 545 of the second heat exchange cell 5412, and may be pumped by a plurality of blades, and discharged to the third heat exchange cell 5413 of the first oil passage 541 through the discharge portion.

The oil discharged to the third heat exchange cell 5413 may move in a zigzag pattern along a circumferential direction to the fourth heat exchange cells 5414 to the seventh heat exchange cells 5417 by a pumping pressure of the oil pumps 470, 471.

The first oil passage 541 and the second oil passage 542 have opposite directions only in the flow of oil, and the passage configurations thereof are the same. The oil of each of the first and second oil passages 541 and 542 may move in the order of the first heat exchange cell 5411 to the seventh heat exchange cell 5417, but may move in opposite directions along a circumferential direction.

The seventh heat exchange cell 5417 of the first oil passage 541 and the seventh heat exchange cell 5417 of the second oil passage 542 may be disposed at a front half portion of the motor housing 50 and at a rear half portion of the motor housing 50, respectively. The seventh heat exchange cell 5417 of the first oil passage 541 and the seventh heat exchange cell 5417 of the second oil passage 542 may be partitioned from each other by an intermediate partition wall.

A plurality of oil inlet ports may be disposed at an upper portion of the seventh heat exchange cell 5417. One of the plurality of oil injection ports may be disposed to communicate with the first oil passage 541 and the other one thereof to communicate with the second oil passage 542. A plurality of oil plugs may be mounted in an open and closed manner on the plurality of oil injection ports, respectively.

Each of the two intermediate partition walls of the first heat exchange cell 5411 and the seventh heat exchange cell 5417 spaced apart in a front-rear direction of the motor housing 50 may extend in an arc shape along a circumferential direction.

The second cooling passage 55 may be disposed inside the first cooling passage 54, and the coolant of the second cooling passage 55 may be configured to exchange heat with the oil of the first cooling passage 54.

The second cooling passage 55 is different from the first cooling passage 54 in that the cooling fluid is coolant and one passage is provided therefor. Other configurations of the second cooling passage 55 are the same or similar to those of the first cooling passage 54, and thus, redundant description thereof will be omitted.

The second cooling passage 55 may include a first heat exchange cell 5501 to a twelfth heat exchange cell 5512 that are spaced apart along a circumferential direction. Since the first heat exchange cell 5501 to the twelfth heat exchange cells 5512 are communicated by communication holes disposed at a front or rear end portion of each of a plurality of partition walls, coolant may move in a zigzag pattern along a circumferential direction.

The first heat exchange cell 5411 is disposed adjacent to a partition wall disposed to radially overlap with the seventh heat exchange cell 5417 of the first oil passage 541 or the second oil passage 542 in a counterclockwise direction (11 o'clock direction).

The coolant inlet port 436 and the coolant outlet port 437 may be disposed in the first heat exchange cell 5501 to communicate with each other. The first heat exchange cell 5501 is partitioned by half of the length direction of the motor housing 50 by an intermediate partition wall (not shown), and a first heat exchange cell 4501 disposed at a front side of the plurality of first heat exchange cell 5501 may be connected to communicate with the coolant inlet port, and the first heat exchange cell 4501 disposed at a rear side thereof to communicate with the coolant outlet portion.

The coolant inlet port 436 and the coolant outlet port 437 may be connected to a coolant circulation system.

The second heat exchange cell 5502 to the fifth heat exchange cell 5505 may be spaced apart from each other in a counterclockwise direction, and a partition wall between the fifth heat exchange cell 5505 and the sixth heat exchange cell 5506 may be disposed at the lowermost end portion of the motor housing 50 among the partition walls of the second cooling passage 55.

The seventh heat exchange cell 5507 to the twelfth heat exchange cell 5512 may be spaced apart from each other in a counterclockwise direction, and the twelfth heat exchange cell 5512 may be disposed adjacent to a partition wall disposed at the uppermost end portion of the motor housing 50 among the partition walls of the second cooling passage 55.

The twelfth heat exchange cell 5512 may communicate with the first heat exchange cell 5411 disposed at a rear half portion of the motor housing 50.

Coolant may flow into the first heat exchange cell 5501 disposed in the front through the coolant inlet port, and move in a zigzag pattern in a counterclockwise direction. The coolant that has moved to the twelfth heat exchange cell 5512 moves to the first heat exchange cell 5501 disposed at a rear side thereof, and the coolant flows out to the outside through the coolant outlet port, and is cooled by heat exchange with air in the radiator, and then circulates through the second cooling passage 45.

A plurality of injection nozzles 444, 445 may be disposed at a partition wall disposed at the uppermost end of the motor housing 40 among the partition walls of the second cooling passage 45 to pass therethrough in a radial direction.

The plurality of injection nozzles 444, 445 may be disposed at front and rear half portions of the motor housing 40, respectively.

An upper side of each of the plurality of injection nozzles 444, 445 may be disposed to communicate with the seventh heat exchange cell 5417 of the first cooling passage 54, and for this purpose, a plurality of connection holes of the seventh heat exchange cell 4417 may be disposed at the second wall 52 to pass therethrough in a thickness direction.

The plurality of oil inlet ports 441, 442 may be disposed at front and the rear end portions of the motor housing 40, respectively.

The plurality of oil inlet ports 441, 442 may be disposed at a partition wall located at the lowest end of the partition walls of the second cooling passage 45 to pass therethrough in a radial direction. A lower side of each of the plurality of oil inlet ports 441, 442 may be disposed to communicate with the first heat exchange cell 5411 of the first oil passage 541 and the second oil passage 542.

According to this configuration, oil may be introduced through the plurality of oil inlet ports 441, 442, and branched in circumferential directions opposite to each other along the first oil passage 541 and the second oil passage 542 by the first oil pump 470 and the second oil pump 471 to rotationally move to an upper portion of the motor housing 40, and then may be injected into an inner space of the motor housing 50 through the injection nozzles 444, 445 of the first oil passage 541 and the second oil passage 542, respectively.

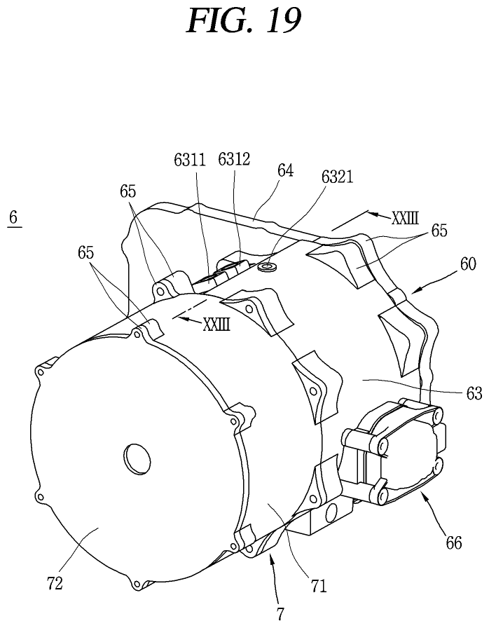

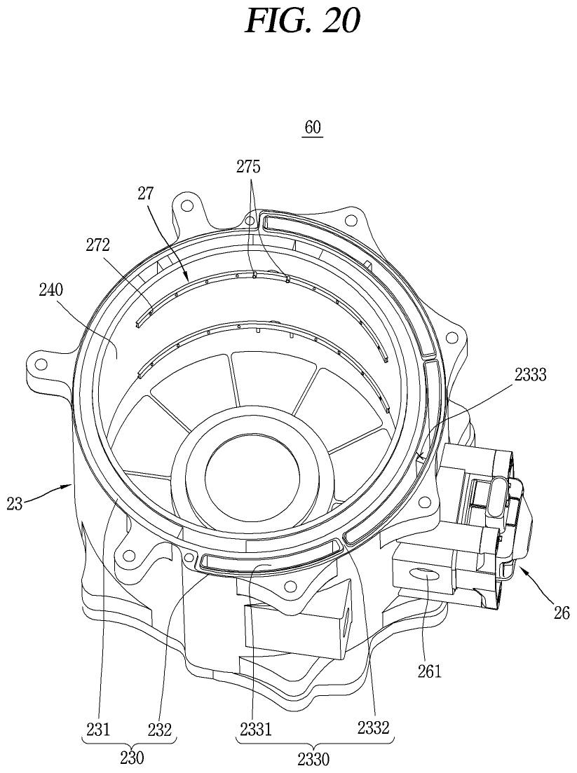

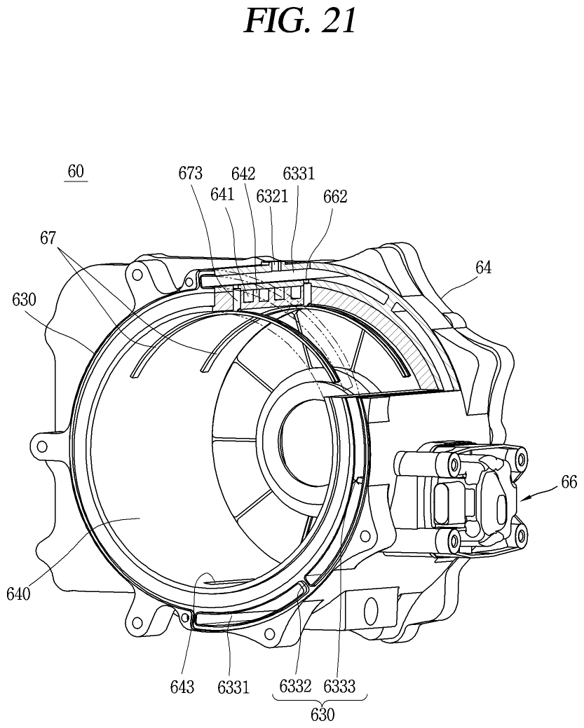

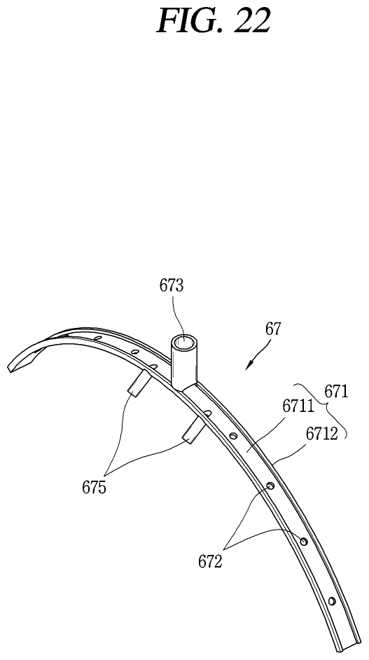

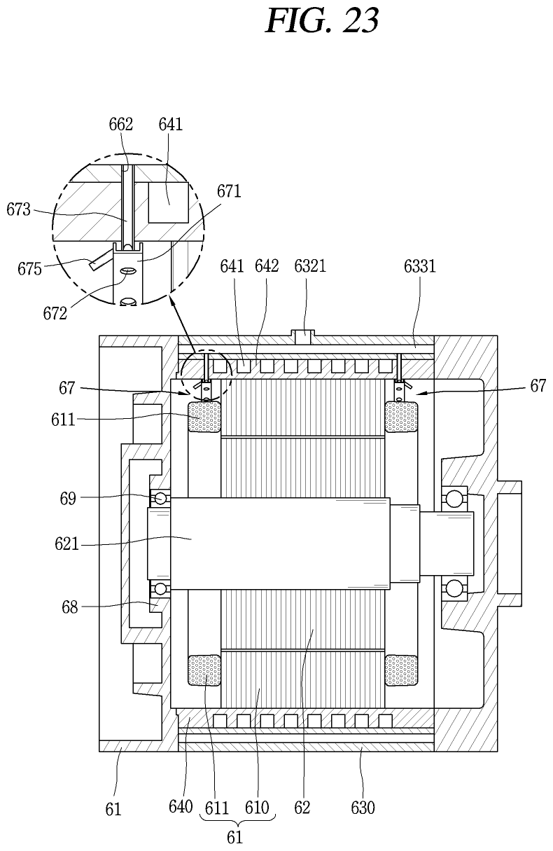

FIG. 19 is a perspective view showing a drive system for driving a wheel of an electric vehicle according to a sixth embodiment of the present disclosure. FIG. 20 is a perspective view showing a bottom surface of an oil distributor provided in a hanging manner on a ceiling of the housing at a rear side of the electric motor in FIG. 19. FIG. 21 is a perspective view showing a state of the oil distributor after removing an inner housing in FIG. 20. FIG. 22 is a perspective view showing the structure of the oil distributor in FIG. 21. FIG. 23 is a cross-sectional view taken along line XXIII-XXIII in FIG. 19.

A drive system 6 of the present disclosure is configured to include an electric motor 60 and an inverter 7 for driving the electric motor 60. The electric motor 60 according to the present disclosure may be applicable to an electric vehicle or a hybrid vehicle. The electric motor 60 may provide a driving force for driving a driving wheel of a vehicle.

The electric motor 60 includes a motor housing 63. A stator 61 and a rotor may be provided inside the motor housing 63. The stator 61 includes a stator core 610 and a stator coil 611 wound around the stator core 610.

The stator core 610 may be defined in a cylindrical shape by stacking and coupling a plurality of electrical steel sheets. The stator core 610 includes a plurality of slots spaced apart along a circumferential direction so that the stator coil 611 is wound therearound.

The stator coil 611 includes an end coil protruding from a plurality of slots in an axial direction of the stator core 610.

The rotor may be provided inside the stator core 610 to rotate with respect to the stator 61. A rotation shaft 621 is provided inside the rotor, and the rotor may be rotatably provided together with the rotation shaft 621.

The motor housing 63 may be configured in a cylindrical shape to accommodate the stator 61 and the rotor.

The motor housing 63 may be open in both directions along an axial direction.

The motor housing 63 may include a plurality of fastening portions 65 at front and rear end portions, respectively.

A rear cover 64 is fastened to a rear end portion of the motor housing 63 to cover a rear side of the motor housing 63. The rear cover 64 is configured to cover the rear side of the motor housing 63 in a plate shape, and a plurality of fastening portions 65 may be arranged to be fastened to the motor housing 63.

The inverter 7 is configured to include a cylindrical inverter housing 71 for accommodating electronic components for driving the electric motor 60 therein. The inverter housing 71 may be fastened to a front end portion of the motor housing 63.

The inverter housing 71 is configured to extend in an axial direction from a front end portion of the motor housing 63, and provided with a plurality of fastening portions 65 protruding radially outward from front and rear end portions of the inverter housing 71, respectively. The plurality of fastening portions 65 may be spaced apart in a circumferential direction.

A front cover 72 is fastened to a front end portion of the inverter housing 71 to cover a front side of the inverter housing 71. The front cover 72 may be configured in a circular plate shape. A plurality of fastening portions 65 protruding from an outer circumferential surface of the front cover 72 in a radial direction may be provided.

Each of the front cover 72, the inverter housing 71, the motor housing 63, and the rear cover 64 may be fastened with bolts through fastening holes disposed in the plurality of fastening portions 65.

The motor housing 63 may have double cooling passages. Each of the dual cooling passages may be configured to flow different fluids. One cooling passage of the dual cooling passages may be configured to allow oil to flow. The other one cooling passage of the dual cooling passages may be configured to flow coolant.

The motor housing 63 may include an outer housing 630 and an inner housing 640.

The outer housing 630 may be defined in a cylindrical shape having a hollow portion therein.

The outer housing 630 may be defined in a cylindrical shape having a hollow portion therein. The outer housing 630 may include a first cooling passage 633 through which oil flows.

To this end, when looking at the motor housing 63 in an axial direction from a front side of the motor housing 63 in which the inverter housing 71 housing is located, a left semicircular portion 631 and a right semicircular portion 632 have the same inner diameter and different outer diameters. The right semicircular portion 632 may have a diameter larger than that of the left semicircular portion 631.

Upper and lower end portions of the left semicircular portion 631 and the right semicircular portion 632 may be disposed to be stepped in a radial direction. The right semicircular portion 632 may be disposed to extend more outwardly along a radial direction than the left semicircular portion 631.

Each of the left semicircular portion 631 and the right semicircular portion 632 may have the same diameter along a length direction.

The first cooling passage 633 may be provided inside the right semicircular portion 632.

An oil injection port 643, 6321 for injecting oil into the first cooling passage 633 may be disposed at an upper end of the right semicircular portion 632. An oil plug may be detachably mounted to block the oil injection port 643, 6321.

The first cooling passage 633 may define a passage for circulating oil.

The first cooling passage 633 may include a plurality of heat exchange cells 6331.

The plurality of heat exchange cells 6331 may be spaced apart from each other along a circumferential direction of the outer housing 630. Each of the plurality of heat exchange cells 6331 may extend along a length direction of the outer housing 630.

The plurality of heat exchange cells 6331 may be partitioned by a plurality of partition walls 6332 extending in a radial direction. Each of the plurality of partition walls 6332 may extend along a length direction of the outer housing 630.

The right semicircular portion 632 is further provided with a communication passage 6333 connecting the heat exchange cells 6331 adjacent to each other in a circumferential direction to communicate with each other, and the plurality of heat exchange cells 6331 may define a single first cooling passage 633.

Each of the plurality of partition walls 6332 may be disposed to have a shorter length in a axial direction than the plurality of heat exchange cells 6331 to connect two heat exchange cells 6331 adjacent to each other in a circumferential direction to communicate with each other.

Each of the plurality of communication passages 6333 may be disposed between a front end or a rear end of the plurality of heat exchange cells 6331 and one end portion of the partition wall 6332, respectively.

Each of the plurality of communication passages 6333 may be disposed alternately at the front end portion and the rear end portion of the plurality of heat exchange cells 6331 along a circumferential direction.

The rear cover 64 may be coupled to cover rear ends of the plurality of heat exchange cells 6331. The rear cover 64 may be alternately and selectively brought into contact with a rear end portion of each of the plurality of partition walls 6332 along a circumferential direction.

A rear end portion of the inverter housing 71 may be coupled to cover front ends of the plurality of heat exchange cells 6331. The rear end portion of the inverter housing 71 may be alternately and selectively brought into contact with a front end portion of each of the plurality of partition walls 6332 along a circumferential direction.

The partition walls 6332 of the plurality of heat exchange cells 6331 may induce a flow direction of oil to flow forward or backward along a length direction of the outer housing 630.

The plurality of communication passages 6333 may guide the flow direction of oil to flow along a circumferential direction.

The plurality of heat exchange cells 6331 may include a plurality of first to fifth heat exchange cells 6331 spaced apart along a circumferential direction from a lower end of the right semicircular portion 632 toward an upper end thereof.

An oil inlet port may be disposed at a bottom surface of the inner housing 640.

Among the plurality of heat exchange cells 6331, the first heat exchange cell 6331 located at the lowermost end of the motor housing 63 may include a cell inlet port communicating with the oil inlet port to allow oil flowing in through the oil inlet port to flow into the first heat exchange cell.

The oil pump 66 may be detachably mounted on a lower right side portion of the motor housing 63. The oil pump 66 may be configured with an electric pump driven by electric energy.

A pump mounting portion may be disposed to protrude from a lower side portion of the right semicircular portion 632 of the outer housing 630. A pump discharge port may be disposed inside the pump mounting portion. A pump suction port 661 may be disposed on a bottom surface of the pump mounting portion.

The pump inlet port may be connected to communicate with the first heat exchange cell 6331 by a connection hose. The pump discharge port may be connected to communicate with the second heat exchange cell 6331.

The oil pump 66 may include a pump housing, a pumping blade, and a pumping motor.

A plurality of coupling portions may be disposed at four corners of each of the pump housing and the pump mounting portion, and the coupling portions may be disposed in the coupling portions, and the pump housing and the pump mounting portion may be screw-coupled by a plurality of screws.

The pumping blade may be rotatably provided inside the pump housing. When the pumping motor is operated, the oil pump 66 may suck oil through the pump suction port 661 and flow it into the pump housing, and then pump oil through the rotation of a pumping blade to discharge it into the second heat exchange cell 6331 through the pump discharge port.

The oil may move in a zigzag pattern along a circumferential direction in the order of the third heat exchange cell 6331 to the fifth heat exchange cell 6331 from the second heat exchange cell 6331.

The oil may move to the fifth heat exchange cell 6331, and then flow out into an upper inner side of the inner housing 640 through a plurality of cell outlet holes 662 disposed on a bottom surface of the fifth heat exchange cell. The plurality of cell outlet holes 662 may be spaced apart from each other along a length direction of the fifth heat exchange cell 6331.

The present disclosure includes a plurality of oil distributors 67 to directly cool the electric motor 60 using oil.

The oil distributor 67 includes a distribution body 671 defined in an arc shape and a plurality of injection holes 672 spaced apart along a circumferential direction of the distribution body 671.

The distribution body 671 may include an arc-shaped curved portion 6711 and a plurality of side surface portions 6712 protruding upward from both sides thereof along a width direction of the curved portion 6711. The curved portion 6711 may be configured with a curved plate.

The curved portion 6711 and the plurality of side surface portions 6712 may have a “⊏”-shaped cross-section that is open upward.

The oil passage connection portion 673 may be disposed at a central portion of the distribution body 671 to extend in an upward direction. The oil passage connection portion 673 may be defined in a circular pipe shape. The oil passage connection portion 673 may have an upper side connected to the cell outlet hole 662 of the oil passage, and a lower side connected to communicate with a central portion of the distribution body 671.

The central portion of the distribution body 671 may be disposed adjacent to the inner uppermost end of the inner housing 640, and the distribution body 671 may extend along a circumferential direction from the inner uppermost end of the inner housing 640 such that an arc length between both end portions of the distribution body 671 is approximately ⅓ of the circumference. However, the arc length of the oil distributor 67 is not limited thereto.

Communication holes 674 may be disposed at a lower end of the oil passage connection portion 673 to be open along a circumferential direction of the distribution body 671 toward both ends thereof.

The oil passage connection portion 673 may be configured to be coupled to the cell outlet hole 662 through an upper wall of the inner housing 640 in a radial direction.

The oil distributor 67 may be provided in a hanging manner on an inner ceiling of the inner housing 640.

The plurality of oil distributors 67 may be provided at front and the rear end portions of the motor housing 63, respectively.

A plurality of injection holes 672 may be disposed at the distribution body 671 to be spaced apart along a circumferential direction. The plurality of injection holes 672 may be disposed at the curved portion 6711 of the distribution body 671 to pass therethrough in a thickness direction or a gravity direction so as to inject oil toward the end coil of the stator coil 611.

The oil distributor 67 may be configured to uniformly distribute oil to the plurality of injection holes 672 along a circumferential direction.

The plurality of injection holes 672 may be disposed such that the spacing becomes narrower from the central portion to both end portions for uniform distribution of oil along a circumferential direction.

A hole diameter of the plurality of injection holes 672 may be disposed to increases from the central portion to both end portions for uniform distribution of oil.

Oil flowing out from the cell outlet hole 662 may descend through the oil passage connection portion 673 to move to the oil distributor 67.

The oil may be distributed to the plurality of injection holes 672 while moving along the oil distributor 67, and the distributed oil may be injected in a radial direction or a gravity direction toward the end coil through each of the plurality of injection holes 672 to absorb heat generated from the stator coil 611.

The oil distributor 67 may further include a plurality of bearing injection nozzles 675.

The bearing mounting portions 68 may be disposed on a rear cover of the inverter housing 71 and a rear cover 64 of the motor housing 71, respectively. The bearing 69 may be insertedly coupled to the bearing mounting portion 68 to rotatably support both ends of the rotation shaft 621.

The bearing 69 may receive heat due to frictional heat caused by the rotation of the rotor core 62 and the rotation shaft 621, or heat generated from a permanent magnet provided in the rotor core 62 may be transmitted to the bearing 69 through the rotor core 62 and the rotation shaft 621.

The bearing 69 injection nozzle 675 is configured to inject oil so as to cool heat generated from the bearing 69.

The bearing injection nozzle 675 may be branched from the oil distributor 67 toward the bearing 69. The bearing injection nozzle 675 may be disposed to be inclined downward toward the bearing 69 from the side surface portion 6712 of the oil distributor 67. The bearing injection nozzle 675 may be defined in a pipe shape.

One end portion of the bearing injection nozzle 675 may be connected to communicate with the oil distributor 67, and the other end of the bearing injection nozzle 675 may communicate with an inner space of the inner housing 640.

Oil may move from the oil distributor 67 to the bearing injection nozzle 675 and may be injected to the end coil through the bearing injection nozzle 675.

The oil distributor 67 is preferably disposed at an upper side of an outer circumference of the stator coil 611 with respect to a horizontal line in a radial direction passing through the center of the stator core 610.

According to this, even when a pumping pressure of the oil pump 66 is reduced, oil may additionally receive gravity in addition to the pumping pressure to be injected to the stator coil 611 and the bearing 69.

According to the oil distributor 67 of the present disclosure, the distribution body 671 of the oil distributor 67 may be defined in a cross-sectional shape that is open upward to reduce pressure loss.

In case of a structure in which an upper surface of the distribution body 671 is closed, a cross-sectional area of oil flowing along an inside of the distribution body 671 decreases, thereby increasing flow resistance so as to increase pressure loss.

In the present disclosure, both side surface portions 6712 of the oil distributor 67 may be disposed in close contact with an inner circumferential surface of the inner housing 640, and an upper opening portion of the distribution body 671 may be configured to be covered by an inner circumferential surface of the inner housing 640.

According to this configuration, oil flowing along the distribution body 671 may be blocked from leaking into a gap between the both side surface portions 6712 and the inner circumferential surface of the inner housing 640, thereby preventing pumping pressure provided to the oil from the oil pump 66 from being lost.

The inner housing 640 may be thermally press-fitted and coupled to an inner circumferential surface of the outer housing 630.

The inner housing 640 may be configured in a cylindrical shape having a hollow portion therein. Both side end portions of the inner housing 640 may be disposed to be open in an axial direction. The inner housing 640 may be disposed to have an outer diameter equal to an inner diameter of the outer housing 630.

The stator 61 and the rotor may be accommodated in a hollow portion of the inner housing 640. The stator core 610 may be press-fitted and coupled to the inner housing 640.

A plurality of second cooling passages 641 may be provided inside the inner housing 640 to flow coolant.

The plurality of second cooling passages 641 may extend in a direction crossing the first cooling passage 633. Each of the plurality of second cooling passages 641 may be disposed to extend along a circumferential direction.

The plurality of second cooling passages 641 may be arranged to be spaced apart along a length direction of the inner housing 640.

A plurality of passage formation portions 642 may extend along a circumferential direction, and protrude from an outer circumferential surface of the inner housing 640 in a radial direction, and may be arranged to be spaced apart along a length direction of the inner housing 640.

Each of the plurality of second cooling passages 641 may be disposed between the two passage formation portions 642 disposed adjacently along a length direction.

Each of the plurality of second cooling passages 641 may be disposed to be open to the outside in a radial direction. Each of the plurality of open second cooling passages 641 may be configured to be covered by an inner wall of the outer housing 630.

Such a radially outward open structure of the second cooling passage 641 may increase a flow cross-sectional area of coolant to reduce pressure loss.

A coolant inlet port 6311 and a coolant outlet port 6312 may be respectively disposed at an upper portion of the left semicircular portion 631 of the outer housing 630. Each of the coolant inlet port 6311 and the coolant outlet port 6312 may be connected to a coolant circulation system.

The coolant circulation system includes a radiator, a water pump and a coolant circulation line.

The radiator is provided in front of the vehicle, and configured to cool coolant by exchanging heat with the coolant through air.

The water pump is configured to circulate coolant along the coolant circulation line.

The coolant circulation line is configured to define a pipe to flow coolant, and to connect the radiator to the coolant inlet port 6311 and the coolant outlet port 6312.

The coolant exchanges heat with the oil of the first cooling passage 633 while flowing along the second cooling passage 641 to absorb heat dissipated from the oil, and the coolant that absorbs the heat flows out through the coolant outlet port 6312, and discharges the heat through the radiator while circulating along the coolant circulation line, and then flows into the second cooling passage 641 of the inner housing 640 through the coolant inlet port 6311 again.

Therefore, according to the present disclosure, even when the oil distributor 67 extending in an arc shape is provided in an inner space of the motor housing 63, and a plurality of injection holes 672 are spaced apart along a circumferential direction of the oil distributor 67 to eliminate a dead zone (an area where oil is not injected from the stator coil 611) in an injection area of oil, and oil is drawn to either one side inside the motor housing 63 while the vehicle is driving uphill or downhill, oil may be evenly injected to the stator coil 611, thereby improving the cooling performance of the electric motor 60.

Furthermore, the bearing injection nozzle may be further provided in the oil distributor 67 to inject oil to the bearing 69 through the bearing injection nozzle, thereby improving the cooling performance of the bearing 69 as well as extending the lifespan of the bearing 69.

Furthermore, the oil distributor 67 may have an open flow path structure that is open upward to increase a flow cross-sectional area of oil, thereby reducing the pressure loss of oil.

Furthermore, a double passage that allows oil and coolant to flow through separate passages, respectively, may be provided inside the motor housing 63, and the oil discharges heat absorbed from the stator coil 611, the bearing 69, and the like, into the coolant and then recirculates to an inside of the motor housing 63, thereby improving the heat dissipation performance of the oil.

Furthermore, according to a dual cooling passage structure of the motor housing 63, an oil-water cooling complex cooling method may be applied to cool and dissipate heat from the electric motor 60 by coolant in a low heating (low output) condition, and perform heat dissipation by coolant and cooling oil in a high heating (high output) condition, thereby improving output density compared to the water cooling type in the related art to drive the electric motor 60 at a higher output with the same size housing.

Moreover, an oil cooler used in the oil cooling type in the related art may be replaced with a double cooling passage disposed inside a wall body of the motor housing 63, thereby reducing cost and implementing a compact structure of the electric motor 60.

Besides, a hybrid operation may be carried out according to a heating state of the electric motor 60, thereby obtaining an advantage of having high efficiency compared to the oil cooling type in the related art in which the oil pump 66 is operated.

In addition, only coolant may be circulated in a low heating condition in which the external environment is at a low temperature to increase the viscosity of oil at a low temperature, thereby reducing the reliability of oil cooling.

1. An electric motor, comprising:
a motor housing;
a stator that includes a stator coil, and that is disposed in the motor housing; and
a rotor that is at least partially surrounded by the stator and is configured to rotate relative to the stator,
wherein the motor housing comprises:
an outer housing that defines at least one first cooling passage through which oil flows;
an inner housing that is disposed in the outer housing, and that defines at least one second cooling passage through which coolant flows, wherein the coolant that flows through the at least one second cooling passage exchanges heat with the first cooling passage; and
a plurality of injection holes that are defined at the inner housing, that communicate with the at least one first cooling passage, and that are configured to inject the oil into the inner housing.

2. The electric motor of claim 1, wherein the at least one first cooling passage extends across the at least one second cooling passage.

3. The electric motor of claim 1, wherein the at least one first cooling passage extends in a longitudinal direction of the outer housing, and the at least one second cooling passage extends in a circumferential direction of the inner housing.

4. The electric motor of claim 1, wherein the outer housing comprises:
a plurality of heat exchange cells that extend along a longitudinal direction in the outer housing;
a plurality of partition walls that are disposed between the plurality of heat exchange cells and that partition the plurality of heat exchange cells; and
a plurality of communication passages that are disposed at one or more of opposite end portions of each of the plurality of partition walls, and that communicate with the plurality of heat exchange cells to define the at least one first cooling passage.

5. The electric motor of claim 4, wherein the plurality of partition walls (i) protrude from an inner wall of the outer housing in a radial direction and (ii) are connected to an outer wall of the outer housing, and
wherein the plurality of communication passages are alternately disposed at opposite ends of the outer housing along a circumferential direction.

6. The electric motor of claim 1, wherein the inner housing comprises:
a plurality of passage formation portions that extend in a circumferential direction in the inner housing;
a passage guide that is spaced apart from the plurality of passage formation portions along the circumferential direction and that extend along a longitudinal direction of the inner housing; and
a common header that is disposed between the plurality of passage formation portions and the passage guide, and that is configured to distribute the coolant to the at least one second cooling passage or collect the coolant from the at least one second cooling passage, and
wherein the at least one second cooling passage is disposed between the plurality of passage formation portions.

7. The electric motor of claim 6, wherein the plurality of passage formation portions protrude radially outward from an inner wall of the inner housing, and
wherein the inner housing is press-fitted into the outer housing such that an outer end of each of the plurality of passage formation portions contacts an inner wall of the outer housing.

8. The electric motor of claim 1, wherein the at least one first cooling passage includes a plurality of first cooling passages, and
wherein the outer housing comprises:
a plurality of passage formation portions that extend in a circumferential direction in the outer housing, and that define the plurality of first cooling passages;
a passage guide that is spaced apart from the plurality of passage formation portions along the circumferential direction, and that extend along a longitudinal direction of the outer housing; and
a common header that is disposed between the plurality of passage formation portions and the passage guide, and that is configured to distribute the coolant to the at least one second cooling passage or collect the coolant from the at least one second cooling passage.

9. The electric motor of claim 8, wherein the inner housing comprises:
a plurality of heat exchange cells that extend in the inner housing along a length direction of the inner housing;
a plurality of partition walls that are disposed between the plurality of heat exchange cells, and that partition the plurality of heat exchange cells; and
a plurality of communication passages that are disposed at one or more of opposite end portions of each of the plurality of partition walls, and that communicate with the plurality of heat exchange cells to define the at least one second cooling passage.

10. The electric motor of claim 1, wherein each of the plurality of injection holes extends in a radial direction at an inner portion of the inner housing, and is configured to inject the oil into the stator coil.

11. The electric motor of claim 10, wherein the plurality of injection holes are disposed at opposite end portions of the inner housing, respectively, along a longitudinal direction of the inner housing.

12. The electric motor of claim 10, wherein the outer housing defines a cell outlet port that communicates the first cooling passage with the plurality of injection holes.

13. The electric motor of claim 10, further comprising:
an oil inlet port that is defined at a bottom surface of the inner housing; and
an oil pump that is mounted on a side surface of the outer housing and that is configured to pump the oil that flows through the oil inlet port into the plurality of injection holes.

14. The electric motor of claim 1, wherein the outer housing comprises:
a first semicircular portion that is disposed in a first section along a circumferential direction; and
a second semicircular portion that is disposed at a second section along the circumferential direction,
wherein the second semicircular portion has a diameter that is larger than a diameter of the first semicircular portion, and
wherein the first semicircular portion and the second semicircular portion define the first cooling passage.

15. The electric motor of claim 14, wherein the outer housing comprises:
a coolant inlet port that is defined the first semicircular portion; and
a coolant outlet port that extends along a circumferential direction and that is defined lower than the coolant inlet port.

16. An electric motor, comprising:
a motor housing that receives a stator and a rotor;
a plurality of oil passages that extend in opposite directions from each other along a circumferential direction in the motor housing;
a plurality of oil pumps that communicate with each of the plurality of oil passages and that are configured to move oil from a first side of each of the plurality of oil passages to a second side of each of the plurality of oil passages;
a plurality of oil inlet ports that are disposed at a first portion of the motor housing and that are configured to allow the oil to flow to the first side of each of the plurality of oil passages; and
a plurality of injection nozzles that are disposed at a second portion of the motor housing and that are configured to inject the oil from the second side of each of the plurality of oil passages into the motor housing.

17. The electric motor of claim 16, further comprising:
a coolant passage that is disposed separately from the plurality of oil passages in the motor housing at an inner side of the plurality of oil passages.

18. The electric motor of claim 17, further comprising:
a controller that is configured to control the plurality of oil pumps,
wherein the controller is configured to stop the plurality of oil pumps during a low-speed and low-torque operation of the electric motor, that is configured to cool the electric motor using coolant, and that is configured to operate at least one of the plurality of oil pumps during a high-speed and high-torque operation of the electric motor.

19. An electric motor, comprising:
a motor housing that receives a stator and a rotor;
a first cooling passage that is disposed in the motor housing and that is configured to flow oil;
a second cooling passage that is disposed separately from the first cooling passage in the motor housing and that is configured to flow coolant;
an oil distributor that extends along a circumferential direction in the motor housing;
a plurality of injection holes that are spaced apart from each other along a circumferential direction at the oil distributor, that extend through the oil distributor in a first direction, and are configured to inject the oil that is distributed by the oil distributor to a stator coil of the stator; and
an oil passage connection portion that connects the first cooling passage with the oil distributor.

20. The electric motor of claim 19, wherein the motor housing comprises:
an outer housing that defines the first cooling passage; and
an inner housing that is disposed in the outer housing, and that defines the second cooling passage, and
wherein the oil distributor comprises:
a curved portion that defines the plurality of injection holes and that has an arc shape; and
a side surface portion that protrudes radially outward from side surfaces of the curved portion along a width direction of the curved portion, and that is configured to define an open passage structure that is open in a second direction opposite to the first direction, and
wherein the open passage structure is covered by an inner circumferential surface of the motor housing.
